(19) United States
(12) Patent Application Publication
(10) Pub. No.: US 2024/0132414 A1
(43) Pub. Date: Apr. 25, 2024

(54) POLYMER-DERIVED CARBIDE AND BORIDE REFRACTORY CERAMICS AND METHOD FOR MAKING SAME

(71) Applicant: TRITON SYSTEM, INC., Chelmsford, MA (US)

(72) Inventors: Brad Pindzola, Cambridge, MA (US); Paul Chirik, Princeton, NJ (US); Peter Viereck, Antwerp (BE); Matthew V. Joannou, Princeton, NJ (US)

(73) Assignee: TRITON SYSTEM, INC., Chelmsford, MA (US)

(21) Appl. No.: 18/329,398

(22) Filed: Jun. 5, 2023

Related U.S. Application Data
(60) Provisional application No. 63/349,498, filed on Jun. 6, 2022.

(51) Int. Cl. C04B 35/80; C04B 35/628; C04B 35/64; C07F 17/00; C08F 130/04; C08F 130/06; C08F 130/08

(52) U.S. Cl. CPC C04B 35/80; C04B 35/6286; C04B 35/64; C07F 17/00; C08F 130/04; C08F 130/06; C08F 130/08; C04B 2235/3244; C04B 2235/3813; C04B 2235/3839; C04B 2235/486; C04B 2235/5252; C04B 2235/782

(57) ABSTRACT

Polymers derived from a metallocene comprising a group IV element and at least one cyclopentadienyl group are described. Methods for preparing refractory ceramics comprising group IV carbides and/or borides using such polymer are also disclosed. In some embodiments, the method for fabricating the refractory ceramic comprises infiltrating a fiber preform with such polymer and pyrolyzing the polymeric fiber preform.

### CLAIM OF PRIORITY

This application claims the benefit of priority to U.S. Provisional Application No. 63/349,498, filed Jun. 6, 2022, which are incorporated herein by reference in their entirety.

### GOVERNMENT INTEREST

This invention was made with Government support under Contracts No. FA8650-26-M-5028 and FA8650-17-C-5076 awarded by the US Air Force. The Government has certain rights in this invention.

### BACKGROUND

Refractory ceramics are structures processed at high temperature and designed for high-temperature applications. Among the different materials available to fabricate refractory ceramics, group IV carbides and borides are key candidates due to their high melting points, toughness, and thermal conductivity. Refractory ceramics containing this type of material can be fabricated using the following methods: chemical vapor deposition (CVD), melt infiltration (MI), and polymer infiltration and pyrolysis (PIP).

The CVD infiltration of continuous fiber matrices has been demonstrated to prepare refractory ceramics made of group IV carbides and borides. This method can generate high purity matrices but is slow, includes expensive starting materials, and generally results in highly porous matrices. The MI infiltration of fiber preform, where the preform is partially carbonized and then exposed to the molten metal to form the corresponding carbide or boride, has also been used to fabricate refractory ceramics containing group IV carbides and borides. However, this method requires special precautions to protect the fiber structure from the molten metal and generally results in mixtures of carbide and metal phases as the metal does not react completely. The PIP infiltration of fiber preform utilizes a polymer to infiltrate the preform followed by pyrolysis under controlled conditions of the polymeric fiber preform to form the desired refractory ceramic. One or more cycles of infiltration and pyrolysis can be performed to obtain refractory ceramics with specific properties, e.g., density. In addition, to allow the ready fabrication of refractory ceramics, polymers have also proven to: (i) require a lower temperature for densification; (ii) reduce impurities that can impact the ceramic properties; and (iii) provide the ability to generate mixed ceramics in a controlled fashion at shorter length scales, e.g., nanometer and micron length scales.

They are only a few polymers available for the PIP fabrication of refractory ceramics like ZrC, HfC, ZrB₂, and HfB₂, and most of the polymers that are used in the art lead to hybrid ceramics instead of pure ceramics, e.g., silicon containing ceramics. For instance, reduced metal oxides in the presence of boron carbide polymer has been demonstrated to produce phase pure metal borides at moderate temperatures and in good yield. The particulate metal oxide precursor, however, makes it challenging to obtain a uniform microstructure. In order to improve this process, metal (Zr, Hf) borohydrides have been reacted with borazine to obtain brittle solids that convert to the corresponding borides in good yield. While these materials show good conversion, their brittle nature, thought to be due to extensive crosslinking, makes them unsuitable for PIP processes. Similarly, an aqueous approach using a complex polymer of chitosan, metaloxychloride, and boric acid has been demonstrated to give a cross-linked gel after drying that convert to the corresponding boride in moderate yield. Another approach uses hafnocene as a building block to prepare heavily cross-linked or rigid-rod polymers. However, the resulting materials have poor solubility, which make them poor candidates for the PIP process. These materials can form the desired carbides but only in moderate yield and as a mixture with carbon.

Therefore, there is a continued need to improve polymers for fabricating refractory ceramics containing group IV carbides and borides, and thereby improve the various steps of fabricating such refractory ceramics.

### SUMMARY

Some embodiments provide a method for preparing a refractory ceramic comprising providing at least one polymer derived from a metallocene comprising a group IV element and at least one cyclopentadienyl group; infiltrating the polymer into a fiber preform to form a polymeric fiber preform; and pyrolyzing the polymeric fiber preform, wherein the refractory ceramic comprises a group IV carbide, a group IV boride, or a combination thereof.

In some embodiments, the metallocene has a Formula (I), (II), (III), (IV), or (V) with a structure:

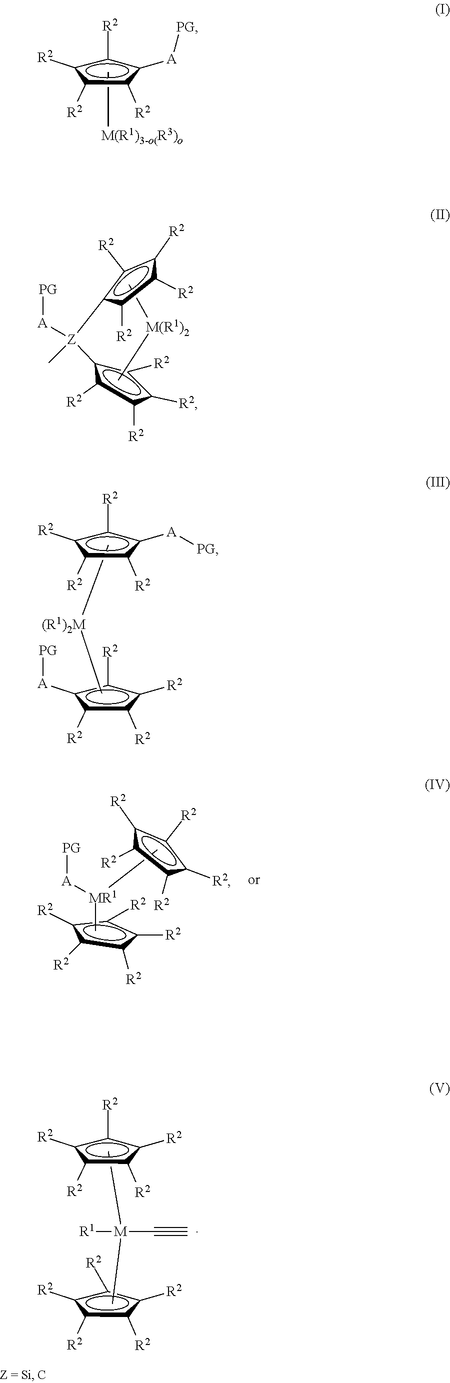

wherein:
M is a group IV element;
A is null, SiH2, Si(H)(CH3), Si(CH3)2, an unsubstituted C1-C6 alkylene, a substituted C1-C6 alkylene, an unsubstituted C1-C6 heteroalkylene, or a substituted C1-C6 heteroalkylene;
PG is a polymerizable group;
each R1 is independently H, BH4, or a halogen;
each R2 is independently H, an unsubstituted C1-C6 alkyl, a substituted C1-C6 alkyl, an unsubstituted C1-C6 heteroalkyl, or a substituted C1-C6 heteroalkyl;
R3 is

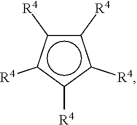

wherein each R4 is independently H, an unsubstituted C1-C6 alkyl, a substituted C1-C6 alkyl, an unsubstituted C1-C6 heteroalkyl, or a substituted C1-C6 heteroalkyl; and
o is 1 or 1.

In some such embodiments, M is Hf or Zr; A is null, Si(CH3)2, or CH2; PG is an ethylene (CH3=CH2-) group; each R1 is independently BH3 or Cl; each R2 is H; and o is 0. In some embodiments, the metallocene is selected from the group consisting of:

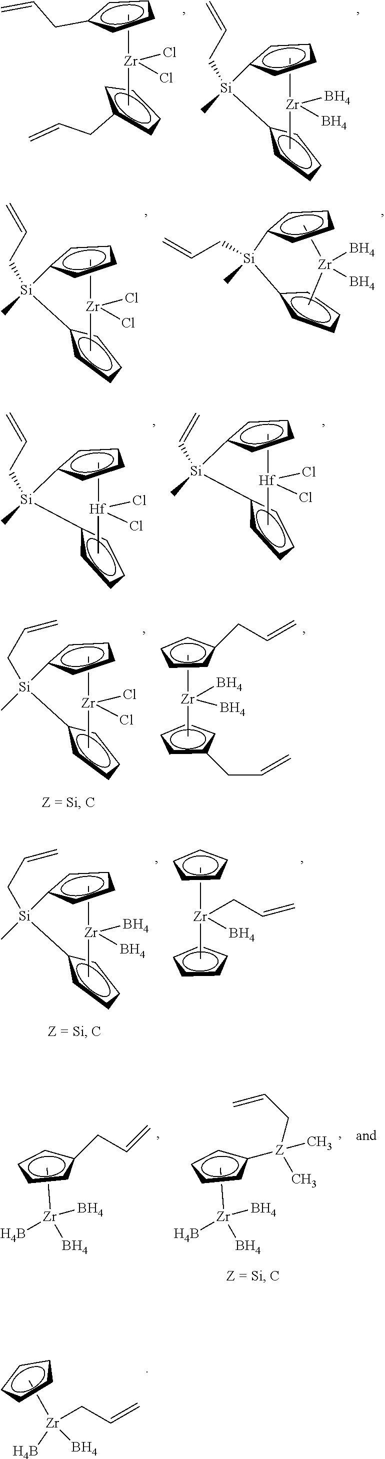

any derivatives thereof, and any combinations thereof.

In some embodiments, the polymer has a Formula (VI), (VII), (VIII), (IX), or (X) with a structure:

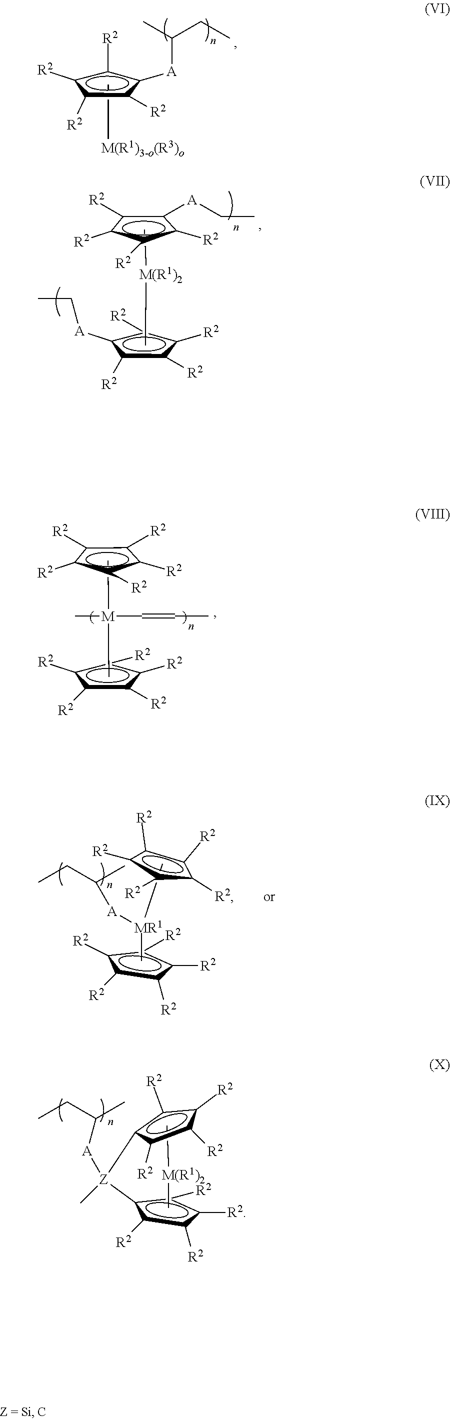

wherein n is an integer between 1 and 500. In some such embodiments, M is Hf or Zr; A is Si(CH3)2 or CH2; each R1 is independently BH4 or Cl; each R2 is independently H or CH3; and o is 0. In some embodiments, the polymer is selected from the group consisting of:

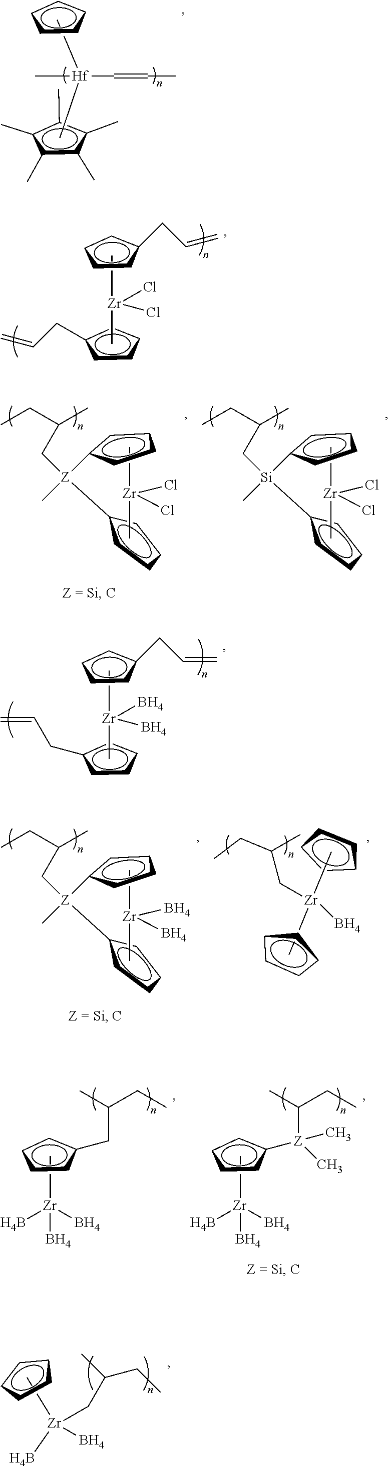

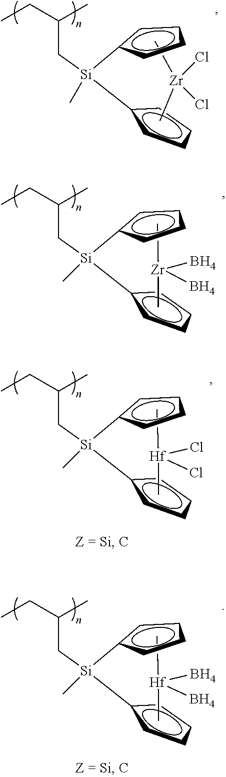

any derivatives thereof, and any combinations thereof.

In some embodiments, the fiber preform is selected from the group consisting of carbon fiber, SiC, HfC, ZrC, or combinations thereof. In some embodiments, the fiber preform is a carbon fiber. In some embodiments, the carbon fiber is coated with pyrolytic carbon. In some embodiments, the carbon fiber is coated with a layer of SiC. In some embodiments, the layer of SiC is deposited by chemical vapor infiltration.

In some embodiments, the polymeric fiber preform is pyrolyzed at a temperature of at least about 1000° C. In some embodiments, the polymeric fiber preform is pyrolyzed at a temperature from about 1000° C. to about 2000° C. In some embodiments, the polymeric fiber preform is pyrolyzed at a temperature from 1200° C. to about 2000° C. In some embodiments, the polymeric fiber preform is pyrolyzed at a temperature from 1400° C. to about 2000° C.

In some embodiments, the polymeric fiber preform is pyrolyzed for at least about 0.5 hour. In some embodiments, the polymeric fiber preform is pyrolyzed for about 0.5 hour to about 5 hours. In some embodiments, the polymeric fiber preform is pyrolyzed for about 1.0 hour to about 5 hours. In some embodiments, the polymeric fiber preform is pyrolyzed for about 2.0 hours to about 5 hours.

In some embodiments, the polymeric fiber preform is pyrolyzed under inert atmosphere. In some embodiments, the inert atmosphere is selected from the group consisting of nitrogen, argon, helium, and any combinations thereof.

In some embodiments, the polymer is a polymer mixture comprising a solvent. In some embodiments, the solvent is selected from the group consisting of ethers, ketones, aromatics or esters, any derivatives thereof, and any mixtures thereof.

In some embodiments, the polymer is a polymer mixture comprising a reactive additive. In some embodiments, the reactive additive is selected from the group consisting of ZrO2, HfO2, SiO2, B2O3, or any carbide forming metal oxide, boron, any derivatives thereof, or any combinations thereof.

In some embodiments, the polymer is a polymer mixture comprising a dispersant. In some embodiments, the dispersant is selected from the group consisting of aprotic anionic, cationic or nonionic surfactants, any derivatives thereof, or any combinations thereof.

In some embodiments, the ceramic composition comprises at least about 30 wt. % of group IV carbide. In some embodiments, the ceramic composition comprises about 30 wt. % to about 90 wt. % of group IV carbide. In some embodiments, the ceramic composition comprises about 45 wt. % to about 90 wt. % of group IV carbide. In some embodiments, the ceramic composition comprises about 60 wt. % to about 90 wt. % of group IV carbide.

In some embodiments, the ceramic composition comprises at least about 30 wt. % of group IV boride. In some embodiments, the ceramic composition comprises about 30 wt. % to about 90 wt. % of group IV boride. In some embodiments, the ceramic composition comprises about 45 wt. % to about 90 wt. % of group IV boride. In some embodiments, the ceramic composition comprises about 60 wt. % to about 90 wt. % of group IV boride.

Some embodiments provide a polymer of Formula (VI), (VII), (VIII), (IX), or (X) with a structure:

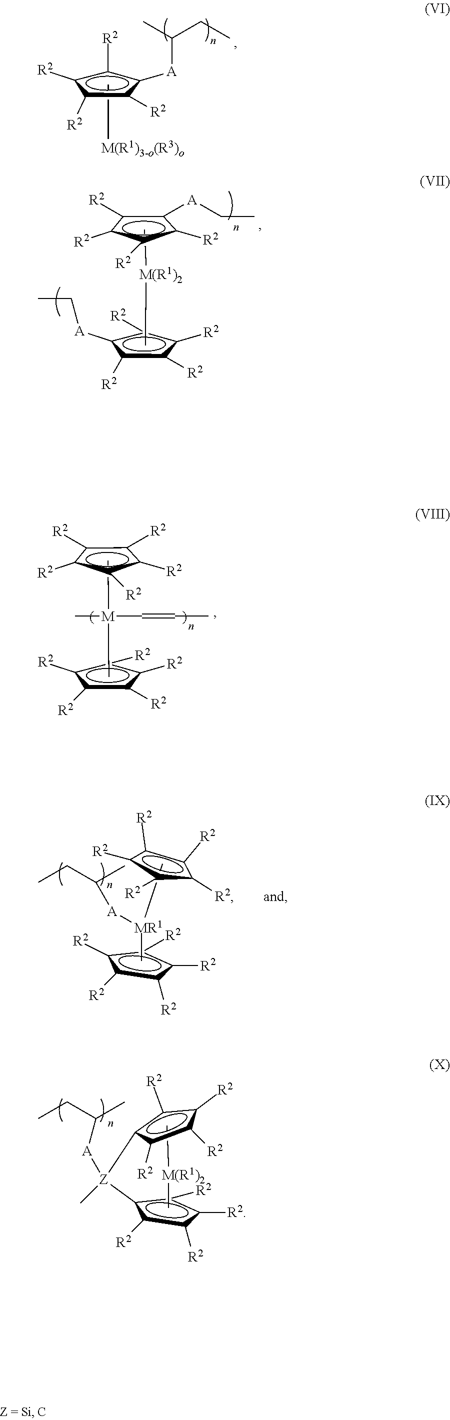

wherein:
M is a group IV element;
A is null, SiH2, Si(H)(CH3), Si(CH3)2, an unsubstituted C1-C6 alkylene, a substituted C1-C6 alkylene, an unsubstituted C1-C6 heteroalkylene, or a substituted C1-C6 heteroalkylene;
each R1 is independently H, BH4, or halogen;
each R2 is independently H, an unsubstituted C1-C6 alkyl, a substituted C1-C6 alkyl, an unsubstituted C1-C6 heteroalkyl, or an substituted C1-C6 heteroalkyl;
R3 is

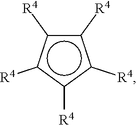

wherein each R4 is independently H, an unsubstituted C1-C6 alkyl, a substituted C1-C6 alkyl, an unsubstituted C1-C6 heteroalkyl, or a substituted C1-C6 heteroalkyl;
n is an integer between xxx and xxx @@ what is the degree of polymerization range?; and
o is 1 or 0.

In some embodiments, M is Zr or Hf; A is null, Si(CH3)2, or CH2; each R1 is independently BH3 or Cl; each R2 is independently H or CH3; and o is 0. In some embodiments, the polymer is selected from the group consisting of:

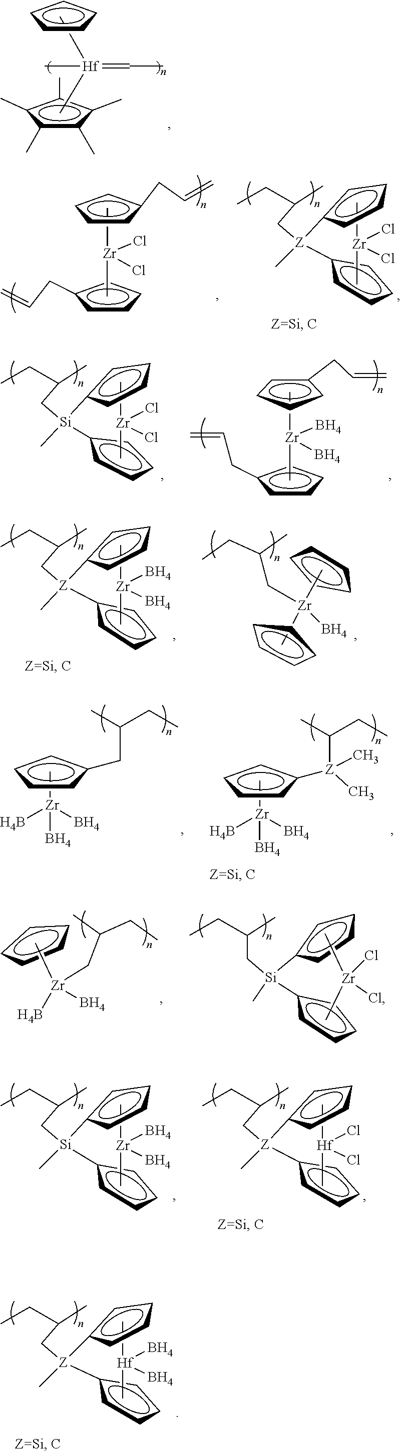

any derivatives thereof, and any combinations thereof.

### BRIEF DESCRIPTION OF THE FIGURES

A detailed description of various embodiments is provided herein below with reference, by way of example, to the following drawings. The skilled person in the art will understand that the drawings, described below, are for illustration purposes only. The drawings are not intended to limit the scope of the applicant's teachings in any way.

In the figures:

FIG. 1 is a flow chart depicting various steps in an exemplary embodiment for the preparation of refractory ceramics in accordance with aspects of the present disclosure;

FIG. 2A is a drawing showing the general molecular representation of cyclopentadienyl borohydride compound Cp₂M(BH₄)₂ (M=group IV element) in accordance with aspects of the present disclosure;

FIG. 2B is a drawing showing the general molecular representation of cyclopentadienyl borohydride compound CpM(BH₄)₃ (M=group IV element) in accordance with aspects of the present disclosure;

FIG. 3 is a drawing showing the molecular representation of a polymerizable metallocene in accordance with aspects of the present disclosure;

FIG. 4 is a graph showing the Simultaneous Thermal Analysis (STA) of Cp₂Zr(BH₄)₂ under Ar at 10° C./min in accordance with aspects of the present disclosure;

FIG. 5 is a graph showing the STA analysis of 1:2 Cp₂Zr(BH₄)₂:ZrO₂ under Ar at 10° C./min in accordance with aspects of the present disclosure;

FIG. 6 is a graph showing the STA analysis of CpZr(BH₄)₃ under Ar at 10° C./min in accordance with aspects of the present disclosure;

FIG. 7 is a graph showing the X-ray Diffraction (XRD) analysis pattern of the residue from STA analysis to 1500° C. of CpZr(BH₄)₃ in accordance with aspects of the present disclosure;

FIG. 8 is a drawing showing the molecular representation of Si-bridge ansa-Cp metallocene compounds in accordance with aspects of the present disclosure;

FIG. 9 is a graph showing the STA analysis to 1500° C. of ansa-zirconocene diborohydride compound in accordance with aspects of the present disclosure;

FIG. 10 is a graph showing the XRD pattern for the residue from STA analysis to 1500° C. of ansa-hafnocene diborohydride showing the formation of HfB₂, HfC, and potentially SiC, in addition to HfO₂ in accordance with aspects of the present disclosure;

FIGS. 11A, 11B, and 11C are a drawings showing the molecular representation of polymetallocene polymers in accordance with aspects of the present disclosure;

FIG. 12 is a diagram showing the synthesis of ansa-(allylmethylsilyl)Cp₂ZrCl₂ in accordance with aspects of the present disclosure;

FIG. 13 is a graph showing Thermogravimetric Analysis (TGA) comparing the thermal decomposition of poly[ansa-(allylmethylsilyl)Cp₂ZrCl₂] to the decomposition of its monomer in accordance with aspects of the present disclosure;

FIG. 14 is a graph showing the XRD pattern of Cp₂Zr(BH₄)₂ after 2 hours at 1500° C. in accordance with aspects of the present disclosure;

FIG. 15A is a scanning electron microscopy (SEM) image showing pyrolyzed Cp₂Zr(BH₄)₂ powder particles in accordance with aspects of the present disclosure;

FIG. 15B is a SEM image showing pyrolyzed Cp₂Zr(BH₄)₂ powder particles in accordance with aspects of the present disclosure;

FIG. 15C is a graph showing the energy dispersive X-ray spectroscopy (EDS) pattern of Cp₂Zr(BH₄)₂ powder particles in accordance with aspects of the present disclosure;

FIG. 15D is a graph showing the EDS pattern of Cp₂Zr(BH₄)₂ powder particles in accordance with aspects of the present disclosure;

FIG. 16 is a graph showing the XRD pattern of 1:2 Cp₂Zr(BH₄)₂/ZrO₂ after 2 hours at 1500° C. in accordance with aspects of the present disclosure;

FIG. 17A is a SEM image of pyrolyzed Cp₂Zr(BH₄)₂ combined with ZrO₂ in accordance with aspects of the present disclosure;

FIG. 17B is a graph showing the EDS pattern of pyrolyzed Cp₂Zr(BH₄)₂ combined with ZrO₂ in accordance with aspects of the present disclosure;

FIG. 18 is a graph showing the XRD pattern of CpZr(BH₄)₃ after pyrolysis at 1500° C. for 2 hours in accordance with aspects of the present disclosure;

FIG. 19 is a SEM image of CpZr(BH₄)₃ after pyrolysis at 1500° C. for 2 hours in accordance with aspects of the present disclosure;

FIG. 20A is an image showing the preceramic formulation containing Cp₂Zr(BH₄)₂, ZrC and toluene in accordance with aspects of the present disclosure;

FIG. 20B is an image showing cast, dried, and pressed disk of Cp₂Zr(BH₄)₂ and ZrC in accordance with aspects of the present disclosure;

FIG. 20C is an image showing the disk of FIG. 20B after pyrolysis at 1500° C. for 2 hours in accordance with aspects of the present disclosure;

FIG. 20D is a SEM image of the pyrolyzed disk of FIG. 20C in accordance with aspects of the present disclosure(inset: low magnification plan view of a piece of the disk);

FIG. 20E is a graph showing the XRD pattern of the pyrolyzed disk of FIG. 20C in accordance with aspects of the present disclosure;

FIG. 21 is a drawing showing the polymerization of metallocenes comprising two cyclopentadienyl group in accordance with aspects of the present disclosure;

FIG. 22 is a drawing showing the polymerization of metallocenes comprising one cyclopentadienyl group in accordance with aspects of the present disclosure; and

FIG. 23 is a drawing showing the molecular representation of copolymers with the ability to control the doping level of Si in the ceramic in accordance with aspects of the present disclosure.

### DETAILED DESCRIPTION

Before the present compounds, compositions, and methods are described, it is to be understood that this invention is not limited to the particular processes, compositions, or methodologies described, as these may vary. It is also to be understood that the terminology used in the description is for the purpose of describing the particular versions or embodiments only, and is not intended to limit the scope of the present invention, which will be limited only by the appended claims. Unless defined otherwise, all technical and scientific terms used herein have the same meaning as commonly understood by one of ordinary skill in the art. Although any methods and materials similar or equivalent to those described herein can be used in the practice or testing of embodiments of the present invention, the preferred methods, devices, and materials are now described. All publications mentioned herein are incorporated by reference in their entirety. Nothing herein is to be construed as an admission that the invention is not entitled to antedate such disclosure by virtue of prior invention.

It must be noted that as used herein and in the appended claims, the singular forms “a”, “an”, and “the” include plural reference unless the context clearly dictates otherwise. Thus, for example, reference to “a polymer” is a reference to “one or more polymers” and equivalents thereof known to those skilled in the art, and so forth.

As used herein, the term “about” means plus or minus 10% of the numerical value of the number with which it is being used. Therefore, “about 50” means in the range of 45%-55%.

As used herein, the term “group IV” or “group IV element” refers to a chemical element belonging to the fourth group in the Periodic Table of the Elements and may include a titanium, zirconium, or hafnium atom.

As used herein, the term “C₁-C₆-alkyl” refers to a linear or branched, saturated or unsaturated, monovalent hydrocarbon group having 1, 2, 3, 4, 5, or 6 carbon atoms.

As used herein, the term “C₁-C₆-alkylene” refers to a linear or branched, saturated or unsaturated, bivalent hydrocarbon group having 1, 2, 3, 4, 5, or 6 carbon atoms.

As used herein, the term “heteroalkyl” refers to an alkyl group, which further includes at least one heteroatom selected from oxygen, nitrogen, or sulfur within (i.e., inserted between adjacent carbon atoms of) and/or placed at one or more terminal position(s) of the parent chain.

As used herein, the term “heteroalkylene” refers to an alkylene group, which further includes at least one heteroatom selected from oxygen, nitrogen, or sulfur within (i.e., inserted between adjacent carbon atoms of) and/or placed at one or more terminal position(s) of the parent chain.

As used herein, the term “Cp” refers to a cyclopentadienyl group, a substituted cyclopentadienyl group, or any derivatives thereof. For instance, Cp can refer to Cp*, the methyl substituted cyclopentadienyl group 1,2,3,4,5-pentamethylcyclopentadienyl.

As used herein, the term “substituted” means that one or more hydrogen atoms on the designated atom or group are replaced with a substituent, provided that the designated atom's normal valency under the existing circumstances is not exceeded. Combinations of substituents and/or variables are permissible. Unless otherwise indicated, it is possible that substituted groups are substituted with as many optional substituents as can be accommodated. The substituent can be any aprotic substituent, including, but not limited to, alkyl, alkenyl, and halide.

As used herein, the term “halogen” refers to a fluorine, chlorine, bromine, or iodine atom, particularly a fluorine, chlorine, or bromine atom.

As used herein, the term “polymerizable group” means any polymerizable group that is known in the art. The “polymerizable group” can be an alkene group, an aldehyde group, an acid group, an amine group, a phosphate group, thiol group, derivatives thereof, or combinations thereof. The “polymerizable group” can be a vinyl (CH₃═CH₂—) group, substituted vinyl groups, methylvinyl, vinyl ethers, acrylic and methacrylic esters, vinyl halides.

Compounds and polymers disclosed herein include diastereomers, racemates, tautomers, N-oxides, hydrates, solvates, salt, and mixtures of same.

It will be understood that the description of compounds and polymers herein is limited by principles of chemical bonding known to those skilled in the art. Accordingly, where a group may be substituted by one or more of a number of substituents, such substitutions are selected so as to comply with principles of chemical bonding with regard to valencies, etc., and to give compounds which are not inherently unstable. For example, any carbon atom will be bonded to two, three, or four other atoms, consistent with the four valence electrons of carbon.

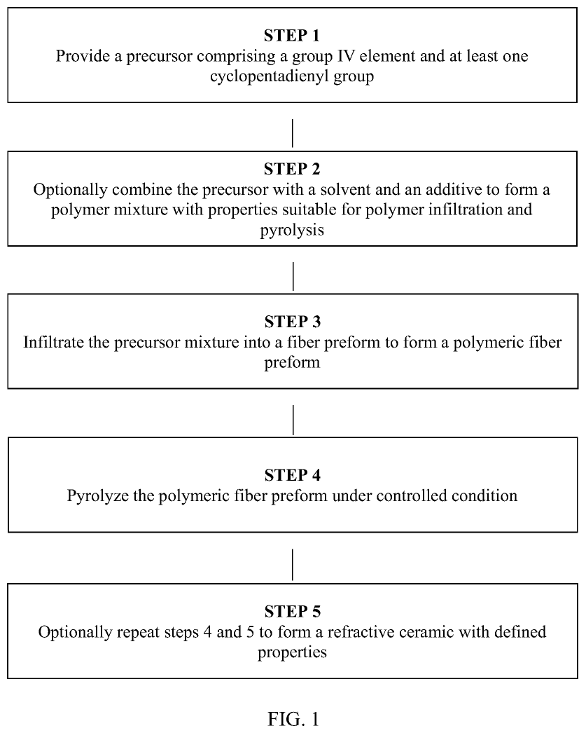

In accordance with certain embodiments, the present disclosure provides a method for preparing a refractory ceramic. The method may include for example the following steps (FIG. 1): (1) providing at least one polymer derived from a metallocene comprising a group IV element and at least one cyclopentadienyl group; (2) infiltrating the polymer into a fiber preform to form a polymeric fiber preform; and (3) pyrolyzing the polymeric fiber preform, wherein the refractory ceramic comprises a group IV carbide, a group IV boride, or a combination thereof.

The metallocene comprising a group IV element and at least one cyclopentadienyl group of the embodiments of this disclosure is not limited and can be any metallocene known in the art. The metallocene can include one cyclopentadienyl group, two cyclopentadienyl groups, or more cyclopentadienyl groups. The metallocene can include Ti, Zr, or Hf, any derivatives thereof, or any combinations thereof. The metallocene can have a Formula (I), (II), (III), (IV), (V) or (VI) with a structure:

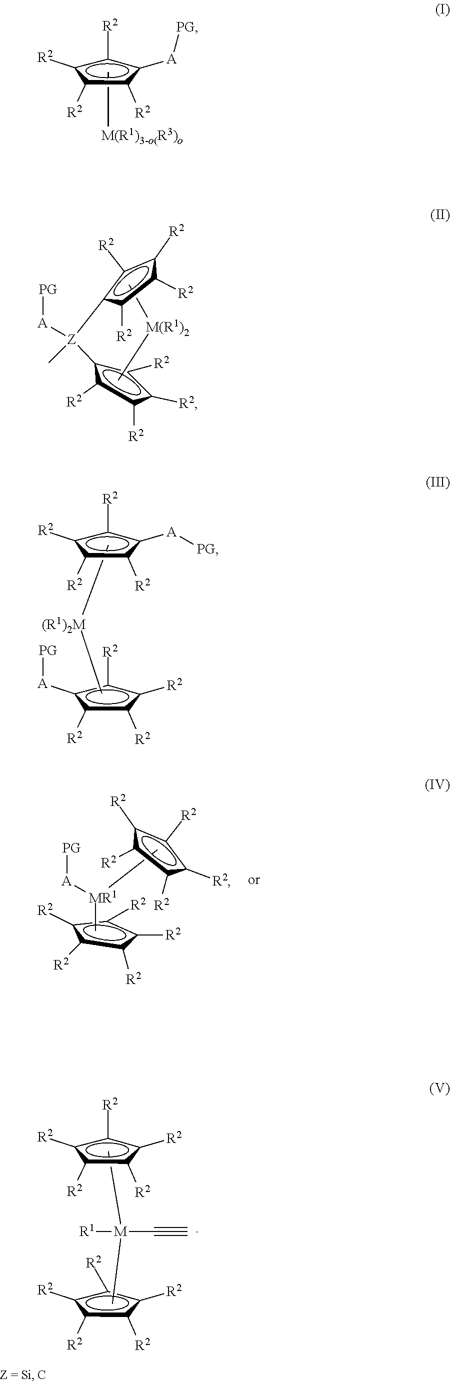

wherein:
M is a group IV element;
A is null, SiH₂, Si(H)(CH₃), Si(CH₃)₂, an unsubstituted C₁-C₆ alkylene, a substituted C₁-C₆ alkylene, an unsubstituted C₁-C₆ heteroalkylene, or a substituted C₁-C₆ heteroalkylene;
PG is a polymerizable group;
each R¹ is independently H, BH₄, or a halogen;
each R² is independently H, an unsubstituted C₁-C₆ alkyl, a substituted C₁-C₆ alkyl, an unsubstituted C₁-C₆ heteroalkyl, or a substituted C₁-C₆ heteroalkyl;
R³ is

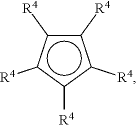

wherein each R⁴ is independently H, an unsubstituted C₁-C₆ alkyl, a substituted C₁-C₆ alkyl, an unsubstituted C₁-C₆ heteroalkyl; or a substituted C₁-C₆ heteroalkyl and
o is 1 or 0.

The metallocene can have the Formula (I), (II), (III), (IV), or (V) wherein:
M is Hf or Zr;
A is null, Si(CH₃)₂, or CH₂;
PG is an ethylene (CH₃═CH₂—) group;
each R¹ is independently BH₄ or Cl; R² is H; and
o is 0.

The metallocene can be selected from the group consisting of:

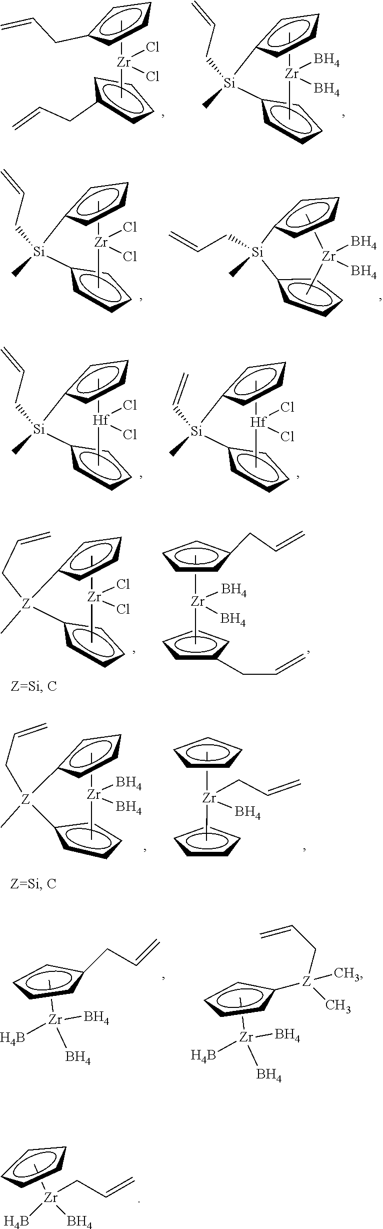

any derivatives thereof, and any combinations thereof.

Without being bound to any theory, varying the degree and type of functional group, e.g., R¹, R², R³, and PG group, attached to a compound, a monomer, a polymer, or a group attached to a compound, a monomer, or a polymer, e.g., a metallocene or a cyclopentadienyl group attached to a metallocene, can vary the solubility of the compound, polymer, or monomer. For example, increasing the degree of methylation on a cyclopentadienyl group that is attached to a metallocene can increase the solubility of the metallocene.

The polymer derived from the metallocene comprising a group IV element and at least one cyclopentadienyl group of the embodiments of this disclosure is not limited and can be any polymer known in the art. The polymer can be an oligomer, a polymer, a linear polymer, a branched polymer, a hyper-branched polymer, a random copolymer, or a block copolymer. The polymer can have a Formula (VI), (VII), (VIII), (IX), or (X) with a structure:

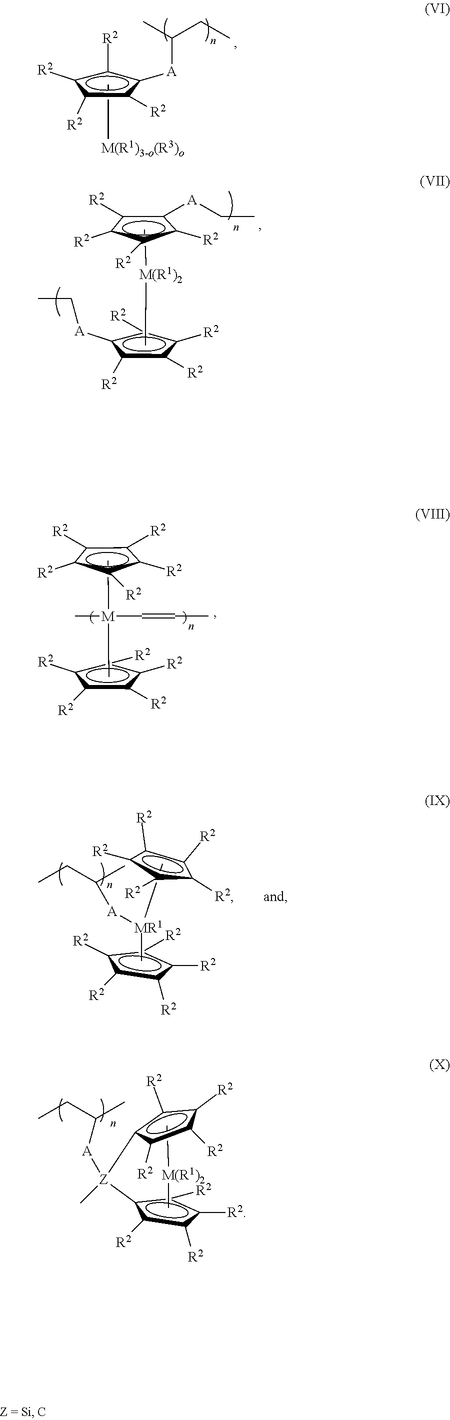

wherein:
M is a group IV element;
A is null, SiH₂, Si(H)(CH₃), Si(CH₃)₂, an unsubstituted C₁-C₆ alkylene, a substituted C₁-C₆ alkylene, an unsubstituted C₁-C₆ heteroalkylene, or a substituted C₁-C₆ heteroalkylene;
each R¹ is independently H, BH₄, or a halogen;
each R² is independently H, an unsubstituted C₁-C₆ alkyl, a substituted C₁-C₆ alkyl, an unsubstituted C₁-C₆ heteroalkyl, or a substituted C₁-C₆ heteroalkyl;
R³ is

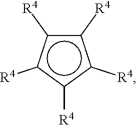

wherein each R⁴ is independently H, an unsubstituted C₁-C₆ alkyl, a substituted C₁-C₆ alkyl, an unsubstituted C₁-C₆ heteroalkyl, or a substituted C₁-C₆ heteroalkyl;
n is an integer from about 1 to about 500; and
o is 1 or 0.

The polymer can have the Formula (VI), (VII), (VIII), (IX), or (X) wherein:
M is Zr or Hf;
A is null, Si(CH₃)₂ or CH₂;
each R¹ is independently BH₄ or Cl;
each R² is independently H or CH₃; and
o is 0.

The polymer can be selected from the group consisting of:

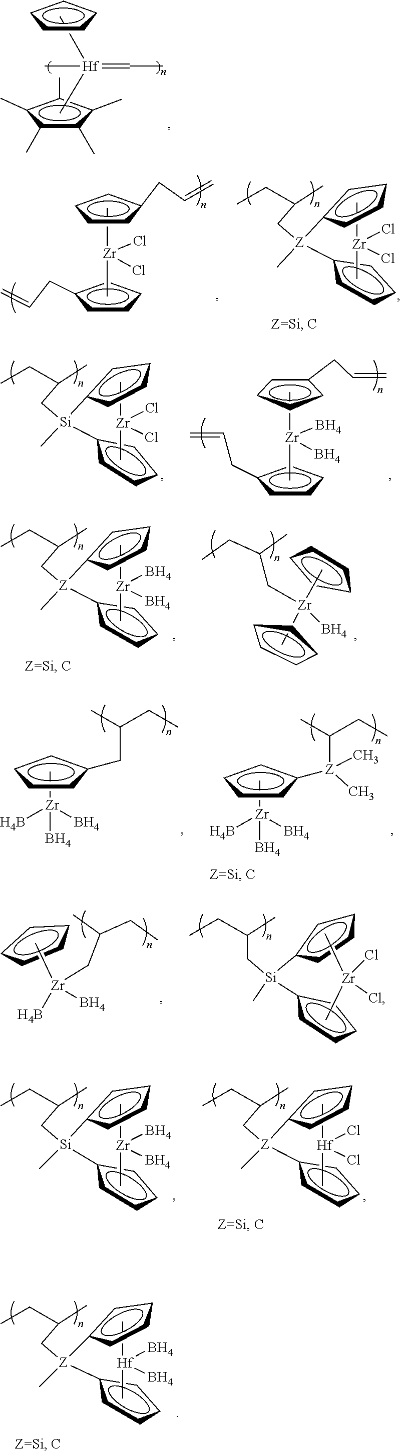

any derivatives thereof, and any combinations thereof.

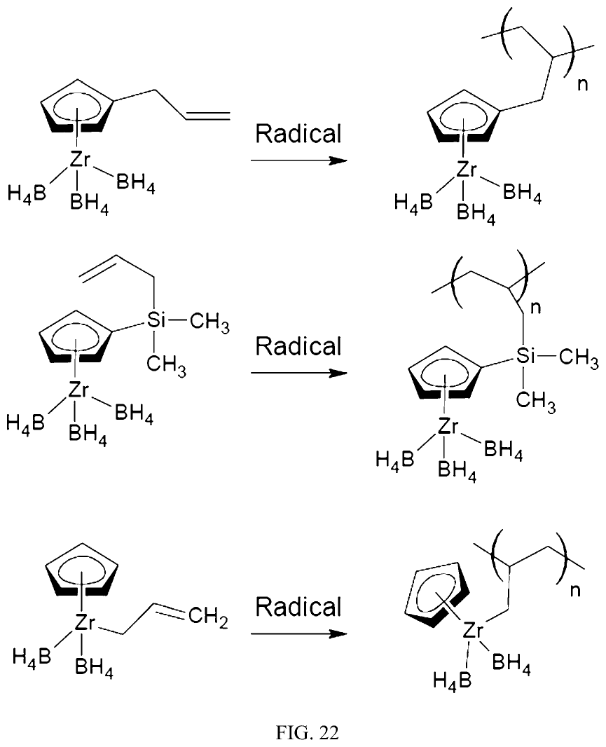

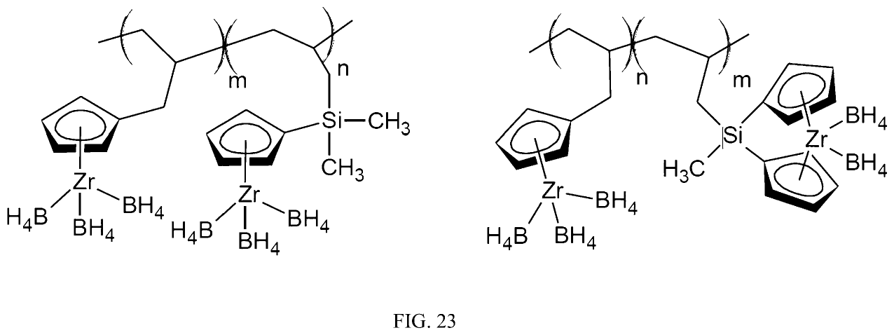

The polymer from the invention can be polymerized in various ways. These include chain-growth polymerization, step-growth polymerization, acyclic diene metathesis (ADMET) polymerization, radical polymerization, and any derivatives thereof. FIGS. 22 shows examples of the polymerization of metallocenes comprising one cyclopentadienyl group, and 23 shows examples of the polymerization of metallocenes comprising two cyclopentadienyl groups.

One of ordinary skill in the art will appreciate that the copolymer disclosed herein can be used to control the composition and doping of the refractory ceramic. For example, the level of Si in the copolymer can be varied to control the amount of Si in the resulting refractory ceramic. This can be a valuable tool for tuning the oxidation resistance of the ceramic. Different group IV elements within the copolymer can also be used to obtain refractory ceramic with different proportions of group IV elements. FIG. 24 shows two exemplary copolymers, wherein m is from about 1 to about 500.

The fiber preform of the embodiments of this disclosure is not limited and is any fiber preform known in the art. The fiber preform relates generally to preform having strips of material that are woven, knitted, braided, stitched, or any combinations thereof. The fiber preform is used to reinforce refractive ceramic materials to produce structural components. One skilled in the art would appreciate that the use of such components is widespread. For instance, the reinforced materials find applications where materials that are light in weight, strong, tough, thermally resistant, self-supporting, and/or adaptable to being formed and shaped are needed. Such components are used, for example, in aeronautic, aerospace, satellite, automobile, nautical, and other applications.

In some embodiments, the fiber preform can include a carbon fiber preform, SiC, HfC, ZrC, mixed systems (ZrC/SiC), any derivatives thereof, or any combinations thereof. The fiber preform can be coated with any of those common in the art, including but not limited to, pyrolytic carbon, a layer of SiC, BN, any derivatives thereof, or any combinations thereof. The fiber preform can be coated using chemical vapor infiltration, chemical vapor deposition, laser CVD, liquid processing, etc., any derivatives thereof, or any combinations thereof.

The step of infiltrating a polymer into a fiber preform to form the polymeric fiber preform disclosed herein can include infiltrating the preform using standard resin infiltration techniques (e.g., vacuum infiltration, wet layup), drying the infiltrated fiber preform, and low-temperature curing of the infiltrated preform. This step can also be combined with other infiltration methods such as melt infiltration and chemical vapor deposition infiltration.

The pyrolysis of the polymeric fiber preform can be performed at controlled parameters to obtain specific properties. The pyrolysis of the polymeric fiber preform can be performed in a furnace. In some embodiments, the pyrolysis of the polymeric fiber preform can be performed at a temperature of at least about 800° C., or about 1000° C., or about 1200° C., or about 1400° C., or about 1600° C., or about 1800° C., or about 2000° C., or about 2200° C., or about 2400° C., or about 2600° C., or about 2800° C., or about 3000° C., or any ranges that is formed from any two of those values as endpoints. In some embodiments, the pyrolysis of the polymeric fiber preform can be performed for at least about 0.2 hour, or about 0.5 hour, or about 1.0 hour, or about 1.5 hour, or about 2.0 hour, or about 2.5 hour, or about 3.0 hour, or about 3.5 hour, or about 4.0 hour, or about 4.5 hour, or about 5.0 hour, or any range that is formed from any two of those values as endpoints. In some embodiments, the pyrolysis of the polymeric fiber preform yields group IV carbide at about 0 wt. %, or at about 10 wt. %, or at about 20 wt. %, or at about 30 wt. %, or at about 40 wt. %, or at about 50 wt. %, or at about 60 wt. %, or at about 70 wt. %, or at about 80 wt. %, or at about 90 wt. %, or at about 100 wt. %, or any ranges that is formed from any two of those values as endpoints. In some embodiments, the pyrolysis of the polymeric fiber preform yields group IV boride at about 0 wt. %, or at about 10 wt. %, or at about 20 wt. %, or at about 30 wt. %, or at about 40 wt. %, or at about 50 wt. %, or at about 60 wt. %, or at about 70 wt. %, or at about 80 wt. %, or at about 90 wt. %, or at about 100 wt. %, or any ranges that is formed from any two of those values as endpoints. In some embodiments, the pyrolysis of the polymeric fiber preform yields a ratio of group IV carbide:group IV boride at about 0:100, or at about 10:90, or at about 20:80, or at about 30:70, or at about 40:60: or at about 50:50, or at about 60:40, or at about 70:30, or at about 80:20, or at about 90:10, or at about 100:0.

The steps disclosed herein, such as the steps to form the refractory ceramic, can include an inert atmosphere. The inert atmosphere of the embodiments of this disclosure is not limited and is any material known in the art. The inert atmosphere can include nitrogen, helium, argon, neon, krypton, xenon, radon, any derivatives thereof, or any combinations thereof. The inert atmosphere could also be at a vacuum or at a partial pressure of any of the inert gases.

The polymer disclosed herein can be a polymer or a polymer mixture comprising a solvent and one or more additives such as a reactive additive, a non-reactive additive, a dispersant, a surfactant, a stabilizer, a dopant, a catalyst, a filler, and any derivatives thereof.

The solvent of the embodiments of this disclosure is not limited and is any solvent known in the art. The solvent can be an organic solvent, an inorganic solvent, or a mixture thereof. The solvent can have the ability to dissolve and/or suspend the polymer, additive, and other solvent. In some embodiments, the solvent can dissolve the polymer at high concentration. In some embodiments, the solvent is a high evaporation solvent that requires less time and energy to remove and therefore can speed fabrication cycles. In some embodiments, the solvent is compatible with use in a production environment. The solvent can include, but is not limited to, THF, toluene, dimethoxyethane, N-methylpyrrole anisole, benzene, any derivatives thereof, or any mixtures thereof.

The additive of the embodiments of this disclosure is not limited and is any additive known in the art. The additive can be an organic additive, an inorganic additive, or a combination thereof, can be a particle, a molecule, or a combination thereof, and can have a millimeter size, a micron size, a nanometer size, an angstrom size, or any combinations thereof.

One skilled in the art would appreciate that reactive and non-reactive additives can be used to increase the overall yield of the system and reach a target yield of carbide, boride, or combination thereof of about 30 vol. %, or about 40 vol. %, or about 50 vol. %, or about 60 vol. %, or about 70 vol. %, or about 80 vol. %, or about 90 vol. %, or about 100 vol. %, or any ranges that is formed from any two of those values as endpoints. Reactive additives can consume extra material produced as byproducts of the ceramitization process, like oxides that undergo carbothermal reduction to consume excesses of carbon and to produce additional carbides. Non-reactive additives, in addition to be able to simply increase the yield, can also act as nucleation centers to improve the conversion of the preceramic materials to the target ceramic. Reactive additives include ZrO₂, HfO₂, SiO2, B2O3, or any carbide forming metal oxide, boron, any derivatives thereof, or any combinations thereof.

In some embodiments, for both reactive and non-reactive additives, nanometer size materials are favored because they have a higher surface area for reaction and nucleation and they can more easily infiltrate fiber structures, e.g., fiber preform. Nanometer size materials are also favored because they can be more easily suspended to generate well-dispersed and stable suspension, which can improve processability.

In some embodiments, a surfactant is added to the polymer or polymer mixture as dispersant and/or stabilizer. The surfactant can have a concentration of about 0.1 wt. %, or about 0.5 wt. %, or about 1.0 wt. %, or about 1.5 wt. %, or about 2.0 wt. %, or about 2.5 wt. %, or about 3.0 wt. %, or about 3.5 wt. %, or about 4.0 wt. %, or about 4.5 wt. %, or about 5.0 wt. %, or about 5.5 wt. %, or about 6.0 wt. %, or about 6.5 wt. %, or about 7.0 wt. %, or about 7.5 wt. %, or about 8.0 wt. %, or about 8.5 wt. %, or about 9.0 wt. %, or about 9.5 wt. %, or about 10.0 wt. %, or any ranges that is formed from any two of those values as endpoints. The surfactant can include a polyurethane and/or polyacrylate with a polar functionality that binds to the particles and a hydrophobic backbone that keeps particles from aggregating through steric hindrance and keeps them suspended by improving compatibility with the solvent. In some embodiments, the surfactant is a positively charged polymer such as a positively charged polymer available from BASF (e.g., Efka® and Dispex® brands) or Dow (TAMOL® brand). Other surfactants that are aprotic and non-reactive to borohydrides may be used, including but not limited to alkyl quaternary ammonium halides, alkyl sulfonates, alkyl sulfates, and any derivatives thereof.

### EXAMPLES

Although the present invention has been described in considerable detail with reference to certain preferred embodiments thereof, other versions are possible. Therefore, the spirit and scope of the appended claims should not be limited to the description and the preferred versions contained within this specification. Various aspects of the present invention will be illustrated with reference to the following non-limiting examples.

### Example 1

### Cyclopentadienyl Borohydrides

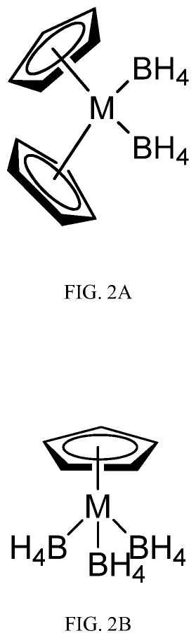

Borohydride derivatives of zirconocene and hafnocene are prepared from the corresponding chlorides by salt metathesis with lithium borohydride and analyzed by Simultaneous Thermal Analysis (STA). FIG. 2 shows the general molecular representation of the cyclopentadienyl borohydride compounds, and Table 1 summarizes the cyclopentadienyl borohydrides prepared and their theoretical and STA yields.

TABLE 1
Borohydrates With Measured Yield
at 1500° C. and Theoretical Yields

| | | | STA Yield | Th. Yield | Th. Yield |
|---|---|---|---|---|---|
| Compound | State | Solubility | (wt. %) | (wt. %) | (vol. %) |
| Cp₂Zr(BH₄)₂ | Solid | Soluble | 52.4 | 41-45 | 11-13 |
| Cp₂Zr(BH₄)₂/ | Solid | Soluble | 59 | 63-65 | 41-49 |
| ZrO₂ | | | | | |
| Cp₂Hf(BH₄)₂ | Solid | Soluble | 69.2 | 56-59 | 11-13 |
| CpZr(BH₄)₃ | Solid | Soluble | 77 | 51-56 | 14-17 |
| Cp*Zr(BH₄)₃ | Solid | Soluble | 56.6 | 38-42 | 10-12 |
| Cp*Hf(BH₄)₃ | Solid | Soluble | 72.1 | 53-56 | 10-12 |

Cp = cyclopentadienyl
Cp* = 1,2,3,4,5-pentamethylcyclopentadienyl

Cp₂Zr(BH₄)₂

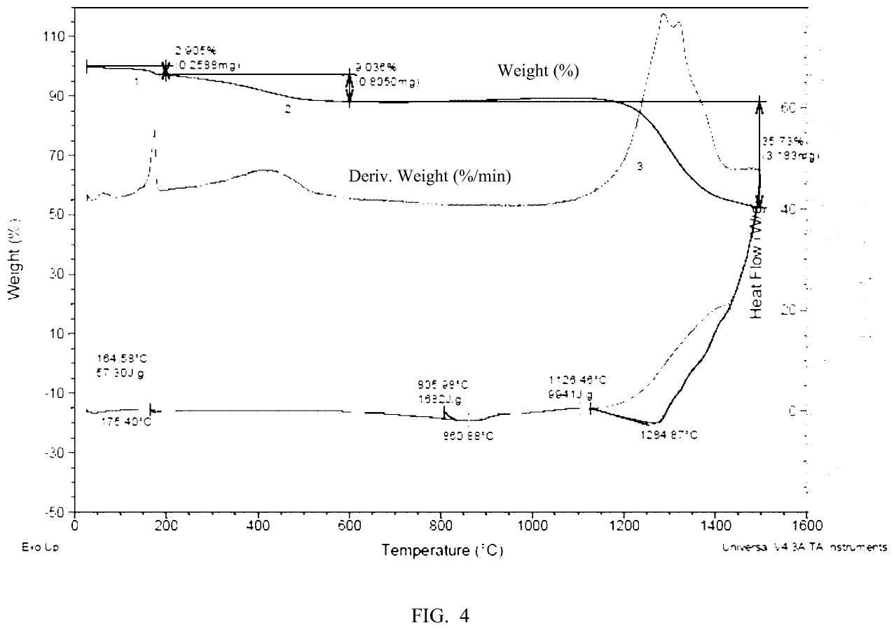

Cp₂Zr(BH₄)₂ is subject to a STA treatment up to 1500° C. (FIG. 2A, M=Zr; and FIG. 4). The observed weight loss occurs in three steps at about 170° C., 425° C., and 1285° C. with an overall yield of 52.4 wt. %. The theoretical yield varies from about 41 wt. % for a conversion to ZrC to about 45 wt. % for a conversion to ZrB₂. Therefore, there is a residual material at this temperature which is likely carbon. This non-polymeric compound shows a high-weight yield, and the likelihood of excess formation of carbon gives the opportunity to utilize a reactive additive, e.g., ZrO₂, to further increase the ceramic yield of the system.

Cp₂Zr(BH₄)₂+ZrO₂

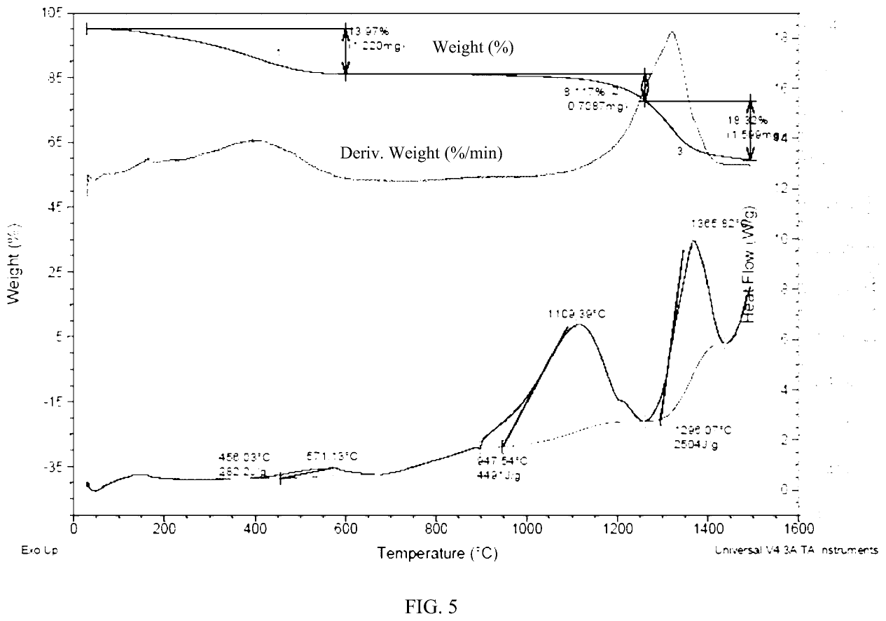

Cp₂Zr(BH₄)₂ with the reactive additive ZrO₂ at a 1:2 Cp₂Zr(BH₄)₂:ZrO₂ molar ratio is subject to a STA treatment up to 1500° C. (FIG. 5). The zirconia is expected to undergo carbothermal reduction at around 1300-1400° C. during the treatment. A similar thermal behavior to the pure zirconocene diborohydride with about 14 wt. % loss up to about 800° C. is observed. Above that temperature, however, there are strong endotherms at around 1100° C. and 1365° C. and an additional loss of 26 wt. %. The strong endotherms are good evidence of the carbothermal reduction, and the overall yield of 59 wt. % is less than what would be expected if the zirconia were only a passive additive and is close to the theoretical yield of 63-65 wt. % for the mixture, assuming complete reaction of the ZrO₂.

The stoichiometry of the STA analysis is chosen based on a Thermogravimetric Analysis (TGA) at 1000° C. Given that the weight loss observed in the STA analysis at about 1300° C. for the pure compound is significantly lower than that seen in the TGA analysis, it suggests that too much zirconia for the available carbon is added and this would result in residual oxide contamination. Matching the addition of reactive additive to available reactants is a key part of developing preceramic systems such as high-yield preceramic systems.

CpZr(BH₄)₃

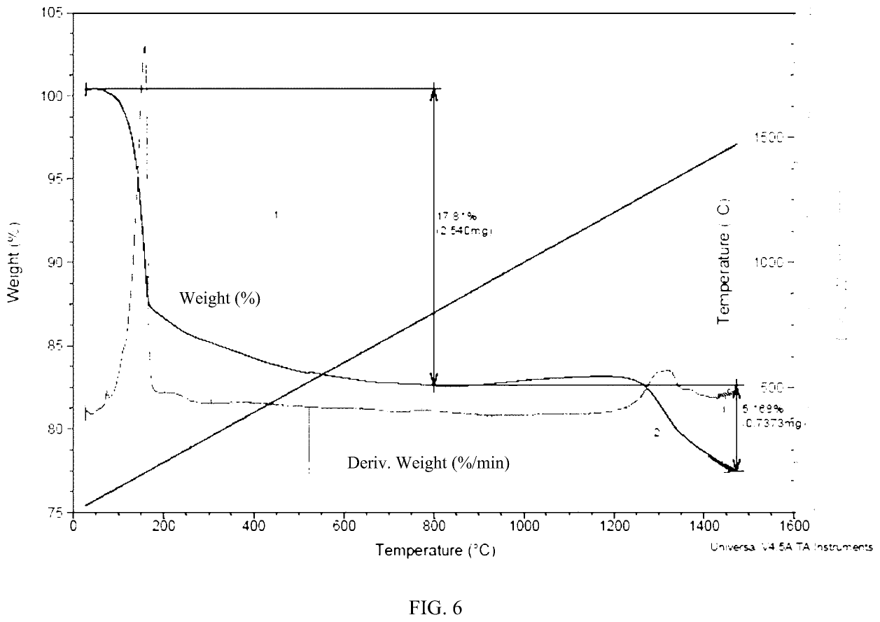

CpZr(BH₄)₃ is subject to a STA treatment up to 1500° C. (FIG. 2B, M=Zr; and FIG. 6). The compound has a relatively large loss of 17.8 wt. % at a low temperature, which peaks at around 150° C., but holds steady past 1200° C. Above this temperature, the compound lost another 5.2 wt. % to end with a total yield of 77 wt. %, which is high compared to the 51-56 wt. % theoretical yield. This makes CpZr(BH₄)₃ another good candidate to use with a reactive additive.

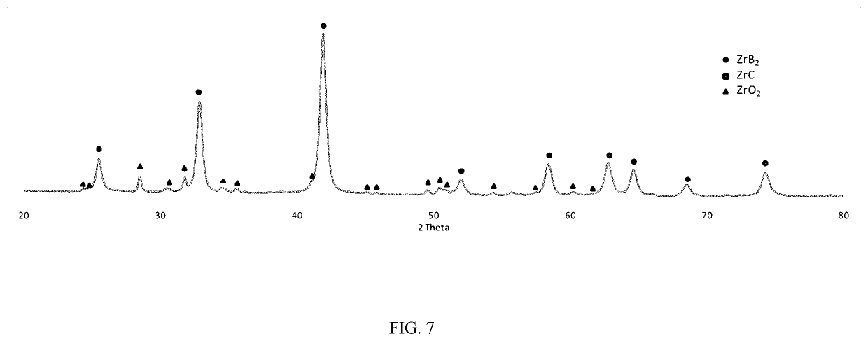

The XRD analysis of the residues from the STA treatment shows that the product comprises about 96% of ZrB₂, about 4% of ZrO₂ contaminant, and no carbide (FIG. 7).

### Example 2

### Polymerizable Cyclopentadienyl Halides and Borohydrides

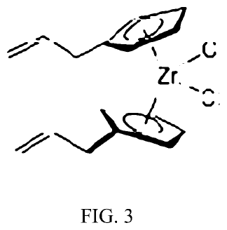

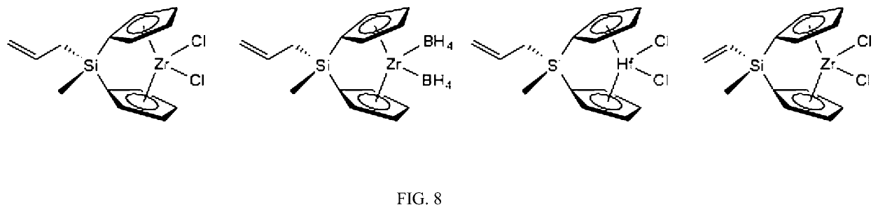

A polymerizable cyclopentadienyl halide compound (FIG. 3) and Si-bridged ansa-Cp metallocene compounds (FIG. 8) are prepared.

### Ansa-Bridged Zirconocene Dichloride

Ansa-bridged zirconocene dichloride is subject to a TGA analysis. An initial 65 wt. % loss between 250-300° C. is observed and followed by a second loss starting at around 475° C. The total residual material is 19 wt. %, which is close to the lower end of the theoretical 28-39 wt. % yield. Note that the range is calculated using pure ZrC for the low end and ZrC+SiC for the high end. The presence of the silyl bridge creates the possibility of making a mixed carbide of Zr and Si, which may be desirable for improved oxidation resistance of the resulting material.

### Ansa-Bridged Zirconocene Diborohydride

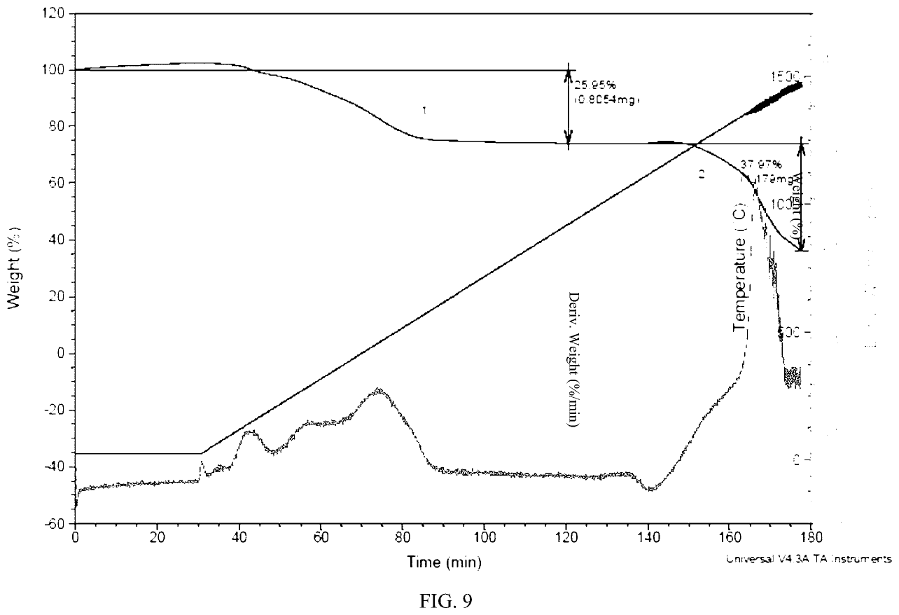

Ansa-bridged zirconocene diborohydride is subject to a STA treatment (FIG. 9). The first weight loss of around 26 wt. % peaks at around 400° C. and the second weight loss of around 38 wt. % peaks at around 1400° C. The overall yield is around 36 wt. %, which compares well to the theoretical yield of 32-47 wt. % and is substantially better than the 19 wt. % observed for the corresponding dichloride.

### Ansa-Bridged Hafnocene Diborohydride

Ansa-bridged hafnocene diborohydride is subject to a STA treatment. A small loss of 2.8 wt. % at around 100° C. is observed and followed by another small loss of 8.4 wt. % between around 250 and 500° C. One final loss of 5.7 wt. % at above 1000° C. is observed. The total yield, therefore, is 83.1 wt. %, relative to the 45-57 wt. % theoretical yield.

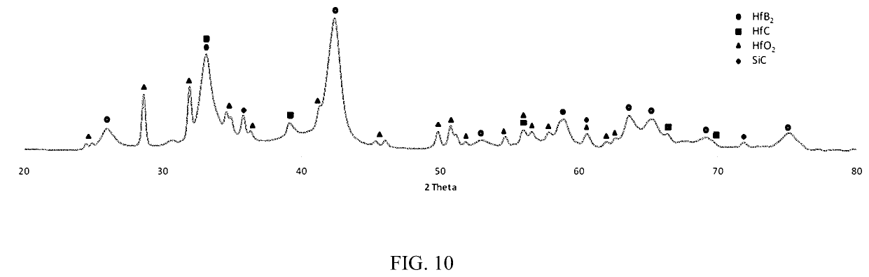

The borohydride versions of the ansa-compounds show much improved yield relative to the original chloride system. The powder X-ray diffraction analysis of the resulting solids also show that the desired phases are made. For example, FIG. 10 shows the XRD pattern for the ansa-hafnocene diborohydride. The presence of HfB 2 is observed and the line broadening indicates nanoscale crystallites. HfC is likely present. SiC may also be present as a few of the peaks appear to fit its pattern best. A substantial amount of oxide is observed as well.

### Example 3

### Polymeric Zirconocene

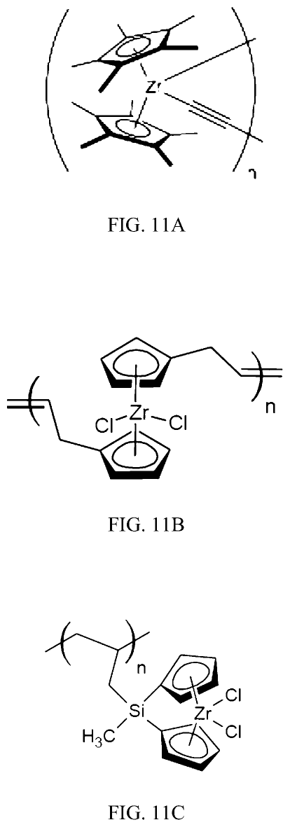

Polymeric zirconocenes are polymerized via three different polymerization mechanisms. First, step-growth reactions between lithium diacetylide and a difunctional zirconocene compound (e.g., Li₂C₂ and Cp₂ZrCl₂) are performed (FIG. 11A). Next, an acyclic diene metathesis (ADMET) polymerization using bis(allylcyclopentadienyl)zirconium dichloride is performed (FIG. 11B). Finally, an allyl-containing ansa zirconium dichloride is polymerized using a radical initiator (FIG. 11C). In the first two cases, the resulting polymer has the metal in the main chain of the polymer, whereas in the last case the resulting polymer has the metal pendant to the main chain. The results are summarized in Table 2.

TABLE 2
Polymetallocenes With Measured Yield at 1000° C. and Theoretical Yields

| | | | TGA Yield | Th. Yield | Th. Yield |
|---|---|---|---|---|---|
| Polymer | State | Solubility | (wt. %) | (wt. %) | (vol. %) |
| poly(Cp*₂Zr—C₂—) | Solid | sl. sol. in | 23 | 42 | 11 |
| | | THF | | | |
| poly[bis(allylCp)ZrCl₂] | Solid | sol. MeOH | — | 32 | 8 |
| poly[(allylCp)₂ZrCl₂] | Solid | sol. MeOH, | 44 | 30 | 8 |
| | | CH₂Cl₂ | | | |
| poly[ansa- | Solid | sol. | 30 | 28-39 | 7 |
| (allylmethylsilyl)Cp₂ZrCl₂] | | | | | |

Cp = cyclopentadienyl
Cp* = 1,2,3,4,5-pentamethylcyclopentadienyl

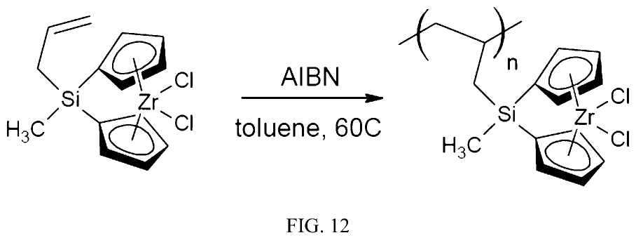

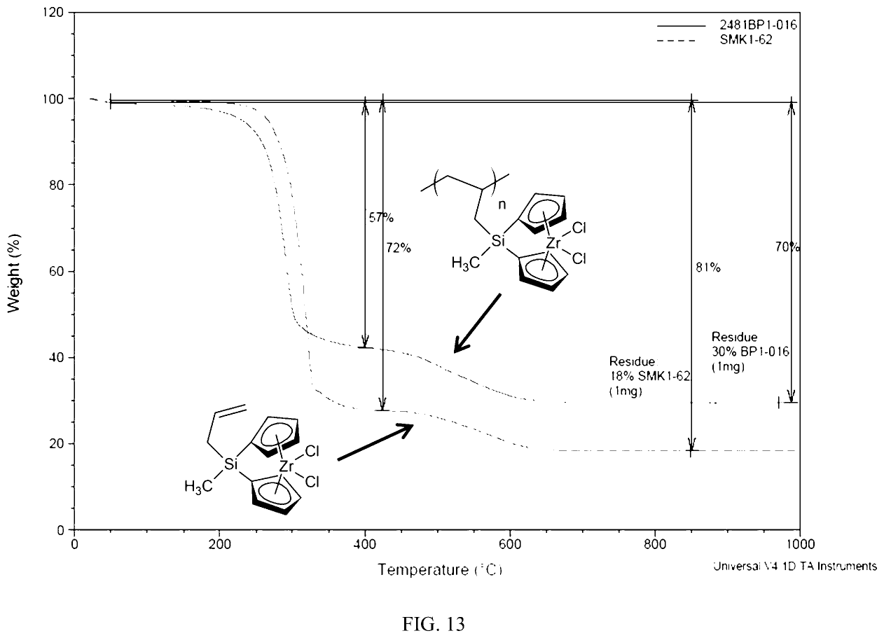

A polymeric zirconocene is polymerized via a radical chain addition polymerization of an ansa-zirconocene compound to make the pendant polymer (FIG. 12). The resulting solid is analyzed by TGA using standard conditions. FIG. 13 compares the TGA analysis of the polymer to that of the monomer. The polymer begins losing mass slightly earlier than the monomer, but only lost around 57% by around 400° C., cf. 72% for the monomer. The second weight loss event, at around 500° C., also begins slightly earlier for the polymer than for the monomer, but also results in smaller mass loss. The final residue for the material is 30 wt. %, which is within the expected 28-39 wt. % range of theoretical yields, again depending on the proportion of ZrC and SiC being formed.

### Example 4

### Pyrolysis of Cp₂M(BH₄)₂ (M=Zr, Hf)

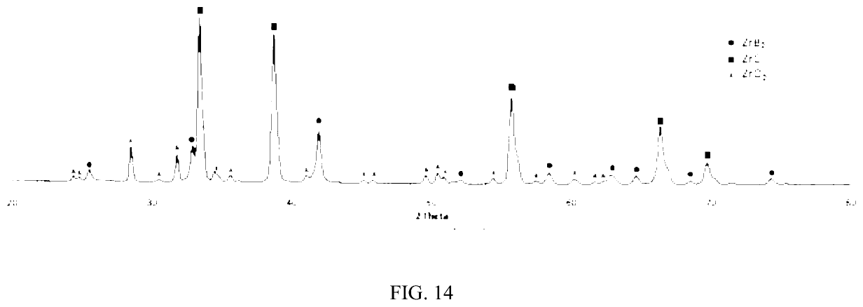

Cp₂M(BH₄)₂ (M=Zr, Hf) are pyrolyzed in covered Mo crucibles in a graphite furnace. The furnace is heated to 200° C. under vacuum, backfilled to 500 Torr with Ar, and subject to a continuous flow of Ar. The temperature is ramped to 1500° C. at 10° C./min and then held at 1500° C. for 2 h. After cooling, the samples are removed for analysis. The results are summarized in Table 3, and the XRD, SEM, and EDS analysis of the resulting ceramics are shown in FIGS. 14-17.

During pyrolysis, the Cp₂Zr(BH₄)₂ is converted from an off-white powder to a black powder at 39 wt. % yield, which is close to the theoretical yield. The Cp₂Hf(BH₄)₂ is converted from an off-white powder to a chunky aggregate at only 17 wt. % yield. The other two samples are zirconocene or hafnocene borohydrides mixed with the corresponding oxide at a ratio calculated to consume excess carbon via carbothermal reduction based on the STA results. From the furnace yields of the pure compounds, however, it appears unlikely that any carbon material remained after 2 h at 1500° C. to react with the oxide by carbothermal reduction.

TABLE 3
Cp₂Zr(BH₄)₂ Compounds Treated at 1500° C. for 2 Hours

| | | | Furnace | |
|---|---|---|---|---|
| | Th. Yield | STA Yield | Yield | |
| Sample | (wt. %) | (wt. %) | (wt. %) | Product |
| Cp₂Zr(BH₄)₂ | 41-45 | 52.4 | 39.0 | ZrB₂, ZrC, ZrO₂ |
| | | | | contamination |
| 1:2 Cp₂Zr(BH₄)₂/ | 63-69 | 59 | 45.1 | ZrC, residual |
| ZrO₂ | | | | ZrO₂ |
| Cp₂Hf(BH₄)₂ | 56-59 | 69.2 | 17.1 | HfB₂, HfC, HfO₂ |
| | | | | contamination |
| 1:1.6 Cp₂Hf(BH₄)₂/ | 70-74 | — | 49.1 | HfC, residual |
| HfO₂ | | | | HfO₂ |

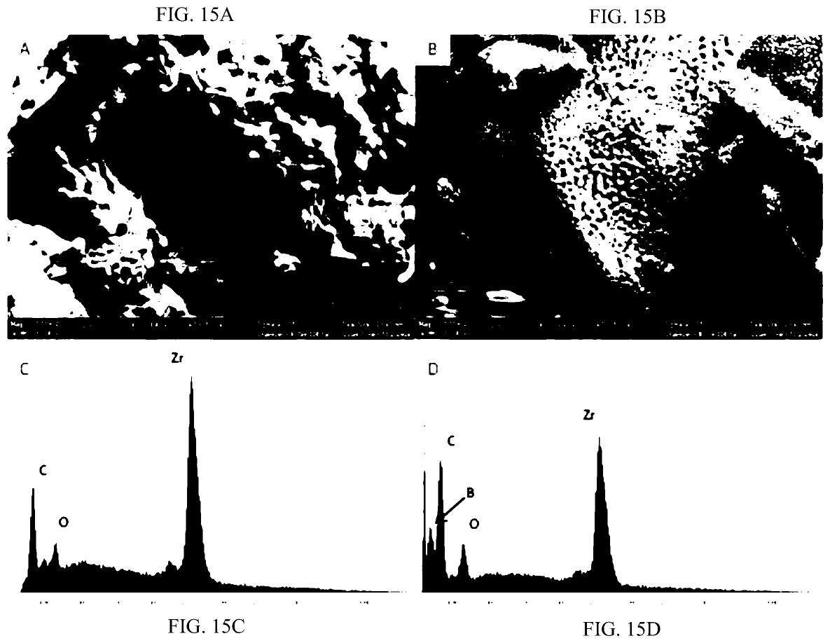

The Cp₂Zr(BH₄)₂ converts to 60% ZrC and 17% ZrB₂ with about 23% ZrO₂ contamination. The peaks observed by XRD analysis are narrow and therefore indicate a certain degree of crystallization (FIG. 14). The SEM/EDS data confirm the formation of a crystalline material with grain sizes on the order of several microns and an elemental composition consisting of Zr, C, B and O (FIG. 15).

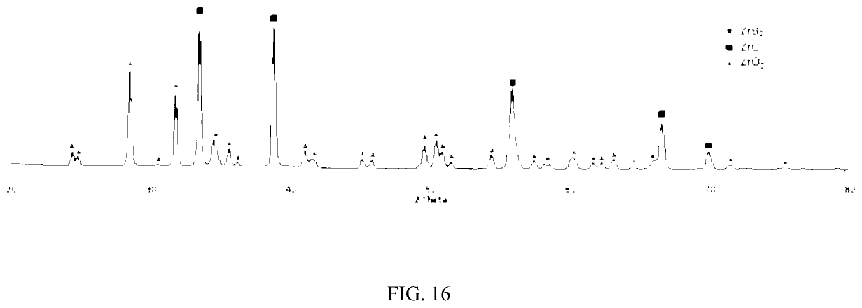

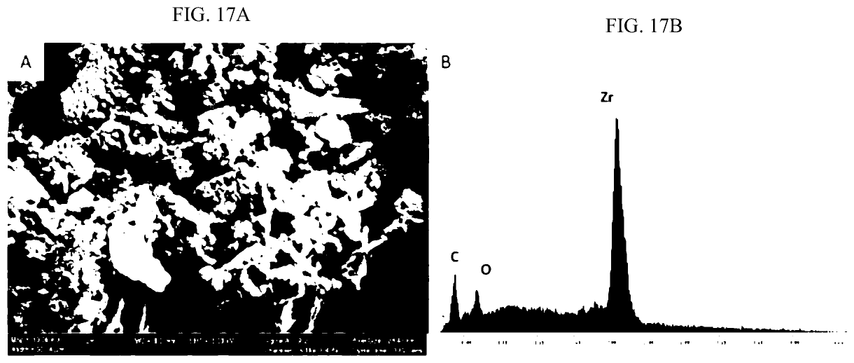

The Cp₂Zr(BH₄)₂ and ZrO₂ mixture is converted during pyrolysis to primarily ZrC (42%) with residual ZrO₂ (58%), and no boride is observed (FIG. 16). The peaks observed by XRD analysis are sharp and therefore indicate a certain degree of crystallization. SEM/EDS data shows a material with good crystallinity, as expected from the XRD, and the expected elemental composition of Zr, C, and O (FIG. 17).

The hafnium version follows a similar pattern. During pyrolysis, the Cp₂Hf(BH₄)₂ converts to a mixture of HfB₂ (53%) and HfC (57%) with only traces of HfO₂ (<1%), and all phases show a certain degree of crystallinity by XRD analysis. The SEM/EDS analysis shows crystalline materials with an elemental composition of Hf, C, and O, and no boron is observed.

The hafnium version with the related oxide follows a similar pattern. During pyrolysis, the mixture of Cp₂Hf(BH₄)₂ and HfO₂ converts to primarily HfC (67%) with residual HfO₂ (33%), and no boride is observed. The peaks observed by XRD analysis are sharp and therefore indicate a certain degree of crystallization. The SEM/EDS analysis shows the mixture of oxide as larger crystallites and carbide as smaller crystallites.

The amount of oxide contamination observed in the furnace runs is substantially lower than that seen in STA runs, which may be due to the more tightly controlled atmosphere in the furnace. The STA treatment of samples likely leads to some level of air contamination. Furthermore, the combination of oxide with these preceramic materials appears to inhibit the formation of the boride. The boron may react with the oxygen released during carbothermal reduction of the oxide, before reacting with the zirconium, to form a volatile species.

### Example 5

### Pyrolysis of CpM(BH₄)₃ (M=Zr, Hf)

CpM(BH₄)₃ (M=Zr, Hf) are pyrolyzed and the results are summarized in Table 4.

TABLE 4
CpZr(BH₄)₃ Compounds Treated at 1500° C. for 2 Hours

| | | | Furnace | |
|---|---|---|---|---|
| | Th. Yield | STA Yield | Yield | |
| Sample | (wt. %) | (wt. %) | (wt. %) | Product |
| CpZr(BH₄)₃ | 51-56 | 77 | 6.4 | ZrC |
| Cp*Zr(BH₄)₃ | 38-42 | 57 | 2.3 | ZrC, 4% ZrO₂ |
| Cp*Hf(BH₄)₃ | 53-56 | 72 | 31 | 70% HfC, |
| | | | | 30% HfB₂ |

Cp = cyclopentadienyl
Cp* = 1,2,3,4,5-pentamethylcyclopentadienyl

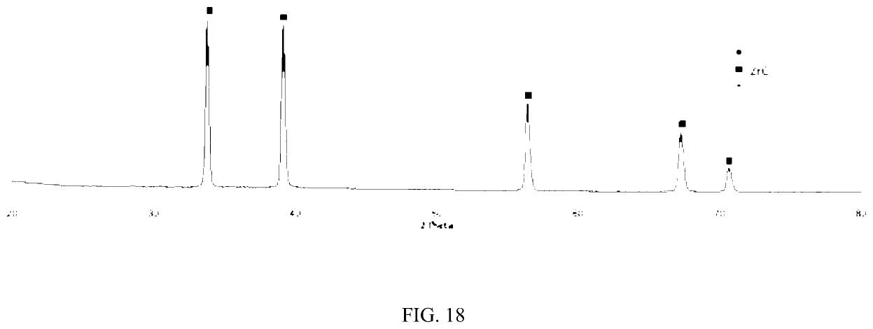

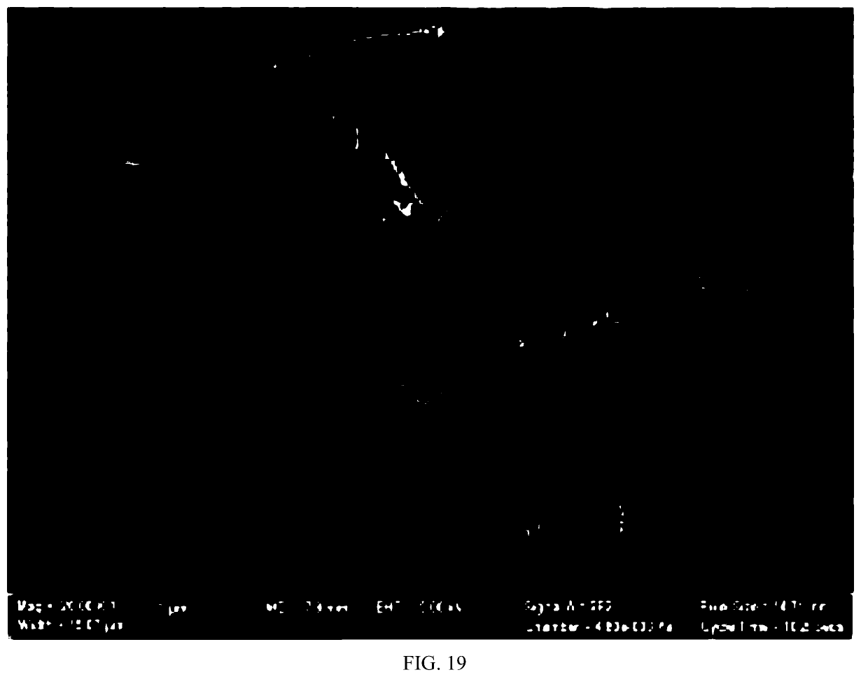

The XRD pattern of the pyrolyzed CpZr(BH₄)₃, shows a complete conversion to highly crystalline ZrC (FIG. 18), and the SEM analysis shows crystalline material in an open, porous network with substantially submicron size crystallites (FIG. 19).

The pyrolysis of the Cp*Zr(BH₄)₃ is similar to the plain-Cp version. The XRD analysis shows that the compound is predominantly composed of ZrC (96%) with a small amount of ZrO₂ contamination (4%). The SEM analysis shows that the compound has a lacey crystalline structure with submicron size crystallites. The Cp*Hf(BH₄)₃, in contrast to the Zr analogs, retained significantly more material and shows a mixture of HfC (70%) and HfB₂ (30%) without oxide contamination by XRD analysis. The SEM analysis shows a similar open crystalline structure with submicron size crystallites, just like the Zr analogs.

### Example 6

### Pyrolysis of Cp₂Zr(BH₄)₂/ZrC disks

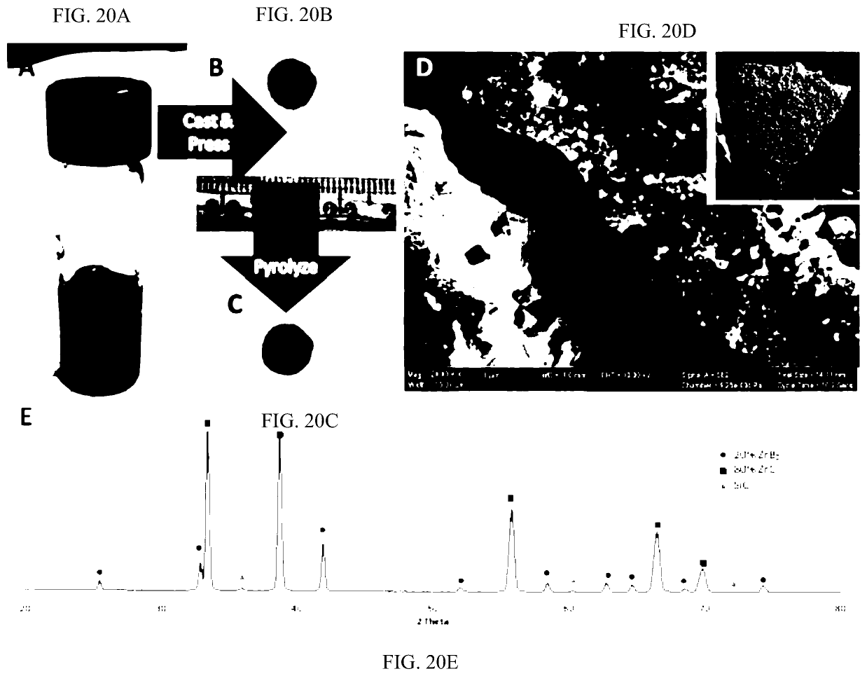

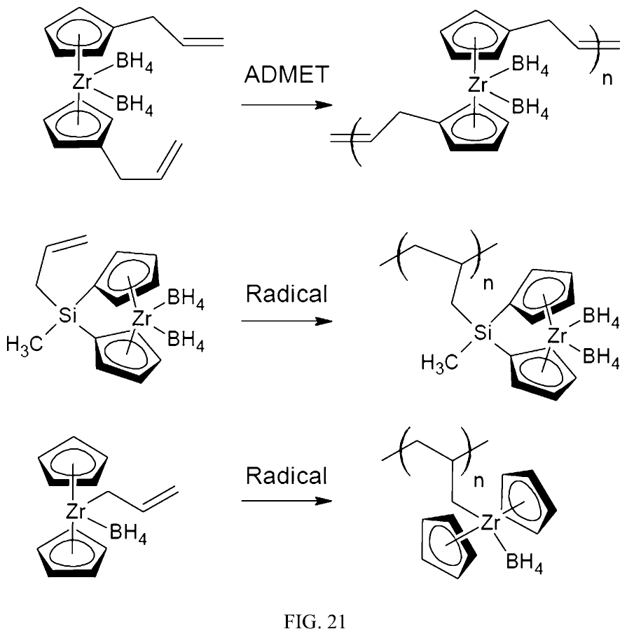

Cp₂Zr(BH₄)₂/ZrC disks are pyrolyzed. First, a mixture of Cp₂Zr(BH₄)₂ and ZrC in toluene is formulated. The zirconocene diborohydride is dissolved in toluene at 0.8 g/mL and 325 mesh ZrC is suspended in the solution (FIG. 20A). The mixture is composed of 13 wt. % zirconocene diborohydride and 26 wt. % ZrC, which after drying and conversion to ceramic is designed to give a 40 vol. % yield. Afterward, this mixture is used to cast and press a disk shaped pellet. The mixture is pipetted into the work area of a twin screw press and allowed to dry. Once dry, the sample is pressed between screws to form a thin and self-supporting disk (FIG. 20B). Then, the disk is pyrolyzed in a Mo crucible and at the end retains its shape and 81% of its weight (FIG. 20C). This yield is close to the upper end of the theoretical weight yield range (72-79 wt. %). The XRD pattern of the resulting material shows a mixture of highly crystalline ZrC (80%) and ZrB₂ (20%) with possible traces of SiC contaminant (FIG. 20E). The SiC contaminant may originate from the ZrC powder that is originally used. The SEM analysis shows a highly crystalline material with a mixture of submicron crystallites, which may be from the zirconocene diborohydride, and micron scale crystals, which may be from added ZrC (FIG. 20D).

What is claimed:

1. A method for preparing a refractory ceramic comprising:
providing at least one monomeric or polymeric metallocene comprising a group IV element and at least one cyclopentadienyl group;
infiltrating the polymer into a fiber preform to form a polymeric fiber preform; and
pyrolyzing the polymeric fiber preform,
wherein the refractory ceramic comprises a group IV carbide, a group IV boride, or a combination thereof.

2. The method of claim 1, wherein the metallocene has a Formula (I), (II), (III), (IV), or (V) with a structure: 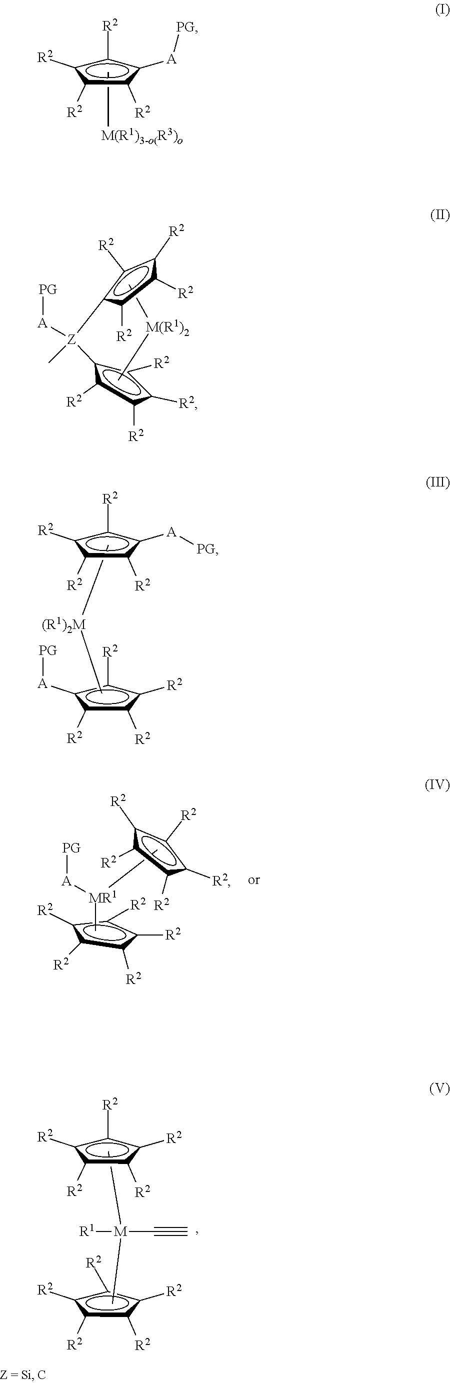
wherein:
M is a group IV element;
A is null, SiH₂, Si(H)(CH₃), Si(CH₃)₂, an unsubstituted C₁-C₆ alkylene, a substituted C₁-C₆ alkylene, an unsubstituted C₁-C₆ heteroalkylene, or a substituted C₁-C₆ heteroalkylene;
PG is a polymerizable group;
each R¹ is independently H, BH₄, or a halogen;
each R² is independently H, an unsubstituted C₁-C₆ alkyl, a substituted C₁-C₆ alkyl, an unsubstituted C₁-C₆ heteroalkyl, or a substituted C₁-C₆ heteroalkyl;
R³ is 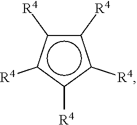
wherein each R⁴ is independently H, an unsubstituted C₁-C₆ alkyl, a substituted C₁-C₆ alkyl, an unsubstituted C₁-C₆ heteroalkyl, or a substituted C₁-C₆ heteroalkyl;
and
o is 1 or 0.

3. The method of claim 2, wherein:
M is Hf or Zr;
A is null, Si(CH₃)₂, or CH₂;
PG is an ethylene (CH₃═CH₂—) group;
each R¹ is independently BH₄ or Cl;
each R² is H; and
o is 0.

4. The method of claim 3, wherein the metallocene is selected from the group consisting of: 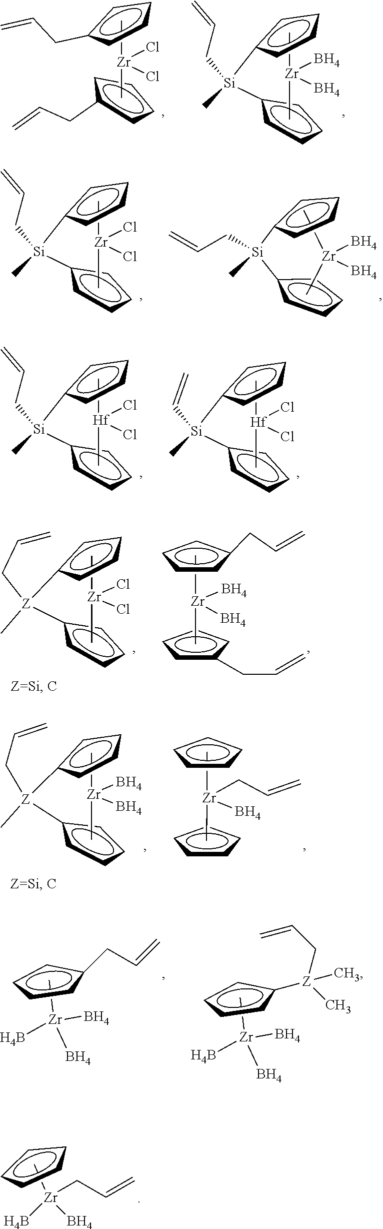
any derivatives thereof, and any combinations thereof.

5. The method of claim 2, wherein the polymer has a Formula (VI), (VII), (VIII), (IX), or (X) with a structure: 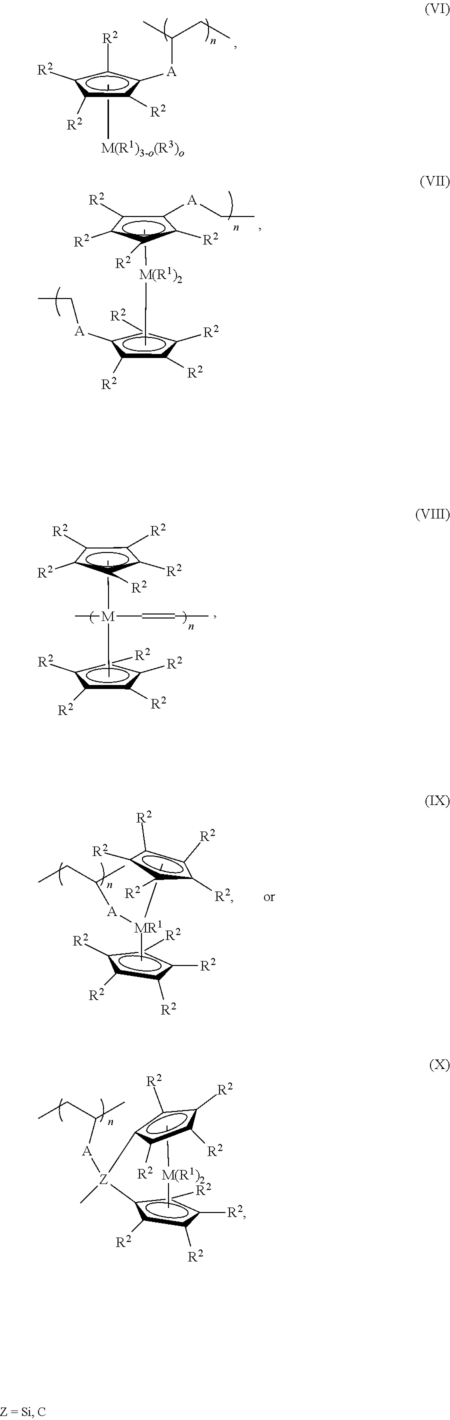
wherein n is an integer between 1 and 500.

6. The method of claim 5, wherein:
M is Hf or Zr;
A is Si(CH₃)₂ or CH₂;
each R¹ is independently BH₄ or Cl;
each R² is independently H or CH₃; and
o is 0.

7. The method of claim 6, wherein the polymer is selected from the group consisting of: 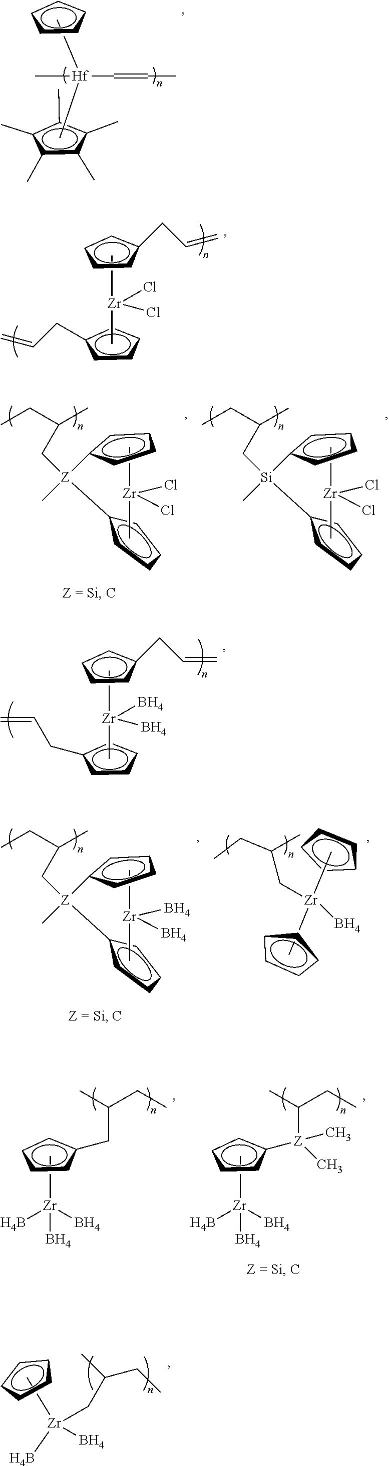 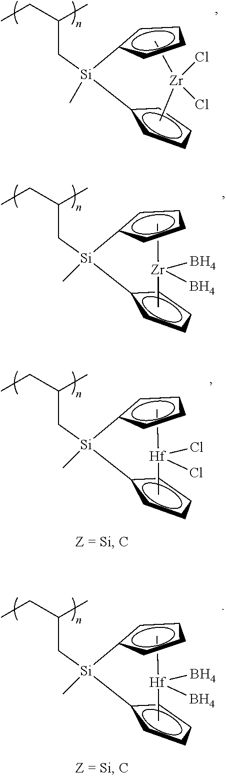
any derivatives thereof, and any combinations thereof.

8. The method of claim 1, wherein the fiber preform is selected from the group consisting of carbon fiber, SiC, HfC, ZrC, or combinations thereof.

9. The method of claim 8, wherein the fiber preform is a carbon fiber.

10. The method of claim 9, wherein the carbon fiber is coated with pyrolytic carbon.

11. The method of claim 10, wherein the carbon fiber is coated with a layer of SiC.

12. The method of claim 11, wherein the layer of SiC is deposited by chemical vapor infiltration.

13. The method of claim 1, wherein the polymeric fiber preform is pyrolyzed at a temperature of at least about 1000° C.

14. The method of claim 13, wherein the polymeric fiber preform is pyrolyzed at a temperature from about 1000° C. to about 2000° C.

15. The method of claim 13, wherein the polymeric fiber preform is pyrolyzed at a temperature from 1200° C. to about 2000° C.

16. The method of claim 13, wherein the polymeric fiber preform is pyrolyzed at a temperature from 1400° C. to about 2000° C.

17. The method of claim 1, wherein the polymeric fiber preform is pyrolyzed for at least about 0.5 hour.

18. The method of claim 17, wherein the polymeric fiber preform is pyrolyzed for about 0.5 hour to about 5 hours.

19. The method of claim 17, wherein the polymeric fiber preform is pyrolyzed for about 1.0 hour to about 5 hours.

20. The method of claim 17, wherein the polymeric fiber preform is pyrolyzed for about 2.0 hours to about 5 hours.

21. The method of claim 1, wherein the polymeric fiber preform is pyrolyzed under inert atmosphere.

22. The method of claim 21, wherein the inert atmosphere is selected from the group consisting of nitrogen, argon, helium, and any combinations thereof.

23. The method of claim 1, wherein the polymer is a polymer mixture comprising a solvent.

24. The method of claim 23, wherein the solvent is selected from the group consisting of, but not limited to, THF, toluene, dimethoxyethane, N-methylpyrrole anisole, benzene, any derivatives thereof, or any mixtures thereof, any derivatives thereof, and any mixtures thereof.

25. The method of claim 1, where in the polymer is a polymer mixture comprising a reactive additive.

26. The method of claim 25, wherein the reactive additive is selected from the group consisting of ZrO2, HfO2, SiO2, B2O3, or any carbide forming metal oxide, boron , any derivatives thereof, or any combinations thereof.

27. The method of claim 1, wherein the polymer is a polymer mixture comprising a dispersant.

28. The method of claim 27, wherein the dispersant is selected from the group consisting of positively charged polymers such as a positively charged polymer available from BASF (e.g., Elka® and Dispex® brands) or Dow (TAMOL® brand), aprotic and non-reactive to borohydrides, including but not limited to alkyl quaternary ammonium halides, alkyl sulfonates, alkyl sulfates, any derivatives thereof, or any combinations thereof.

29. The method of claim 1, wherein the ceramic composition comprises at least about 30 wt. % of group IV carbide.

30. The method of claim 29, wherein the ceramic composition comprises about 30 wt. % to about 90 wt. % of group IV carbide.

31. The method of claim 29, wherein the ceramic composition comprises about 45 wt. % to about 90 wt. % of group IV carbide.

32. The method of claim 29, wherein the ceramic composition comprises about 60 wt. % to about 90 wt. % of group IV carbide.

33. The method of claim 1, wherein the ceramic composition comprises at least about 30 wt. % of group IV boride.

34. The method of claim 33, wherein the ceramic composition comprises about 30 wt. % to about 90 wt. % of group IV boride.

35. The method of claim 33, wherein the ceramic composition comprises about 45 wt. % to about 90 wt. % of group IV boride.

36. The method of claim 33, wherein the ceramic composition comprises about 60 wt. % to about 90 wt. % of group IV boride.

37. A polymer of Formula (VI), (VII), (VIII), (IX), or (X) with a structure: 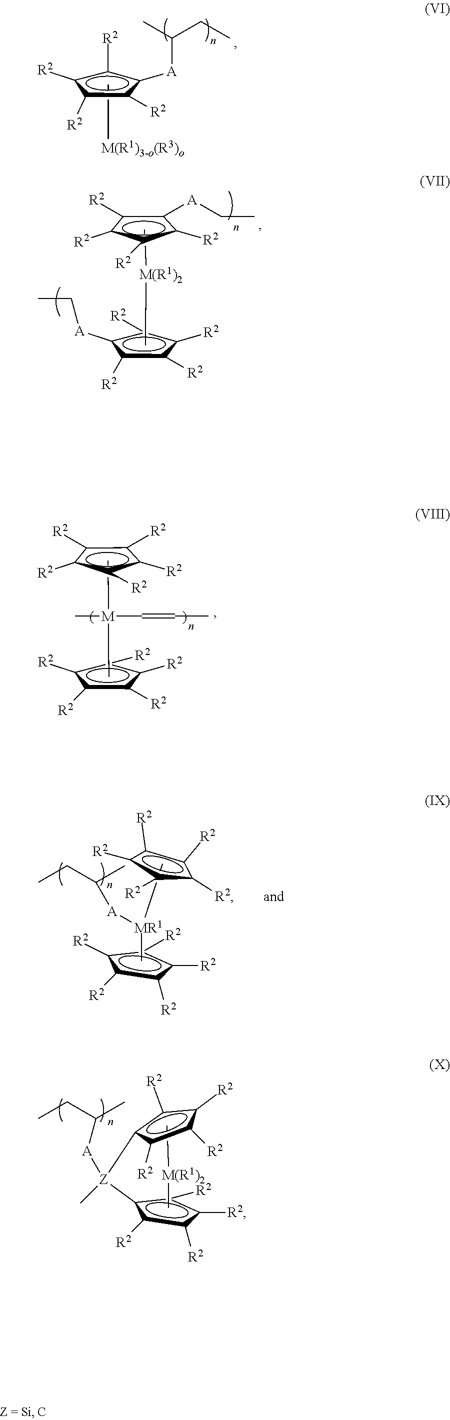
wherein:
M is a group IV element;
A is null, SiH₂, Si(H)(CH₃), Si(CH₃)₂, an unsubstituted C₁-C₆ alkylene, a substituted C₁-C₆ alkylene, an unsubstituted C₁-C₆ heteroalkylene, or a substituted C₁-C₆ heteroalkylene;
each R¹ is independently H, BH₃, or halogen;
each R² is independently H, an unsubstituted C₁-C₆ alkyl, a substituted C₁-C₆ alkyl, an unsubstituted C₁-C₆ heteroalkyl, or an substituted C₁-C₆ heteroalkyl;
R³ is 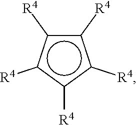
wherein each R⁴ is independently H, an unsubstituted C₁-C₆ alkyl, a substituted C₁-C₆ alkyl, an unsubstituted C₁-C₆ heteroalkyl, or a substituted C₁-C₆ heteroalkyl;
n is an integer between 1 and 500; and
o is 1 or 0.

38. The polymer of claim 37, wherein:
M is Zr or Hf;
A is null, Si(CH₃)₂, or CH₂;
each R¹ is independently BH₄ or Cl;
each R² is independently H or CH₃; and
o is 0.

39. The polymer of claim 38, wherein the polymer is selected from the group consisting of: 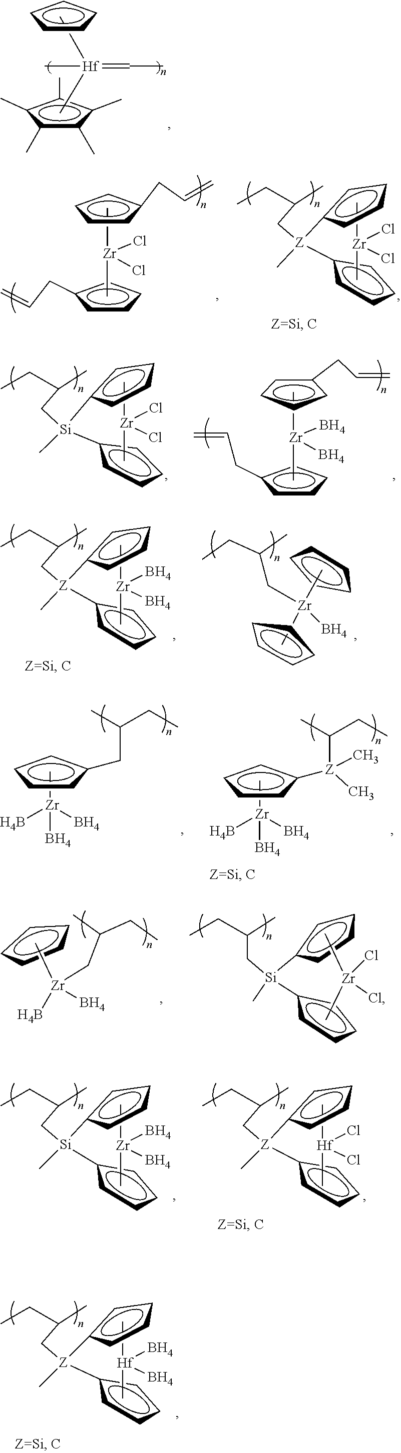
any derivatives thereof, and any combinations thereof.
